(19) United States
(12) Patent Application Publication
(10) Pub. No.: US 2026/0333451 A1
(43) Pub. Date: Oct. 22, 2026

(54) RANDOM ACCESS CHANNEL CONFIGURATIONS WITH ADAPTATION BETWEEN SUBBANDS OF AN ACTIVE BANDWIDTH PART

(71) Applicant: QUALCOMM Incorporated, San Diego, CA (US)

(72) Inventors: Diana MAAMARI, San Diego, CA (US); Muhammad Sayed Khairy ABDELGHAFFAR, San Jose, CA (US); Gabi SARKIS, San Diego, CA (US); Ahmed Attia ABOTABL, San Diego, CA (US)

(21) Appl. No.: 19/183,539

(22) Filed: Apr. 18, 2025

(51) Int. Cl. H04W 74/0833

(52) U.S. Cl. CPC H04W 74/0833

(57) ABSTRACT

Systems and techniques are provided for wireless communications. A user equipment (UE) can obtain configuration information indicative of a set of parameters associated with an active bandwidth part (BWP), the configuration information corresponding to at least a first and second bandwidth within the active BWP and including parameters indicative of a plurality of configured RACH occasions (ROs) within the active BWP. A set of valid ROs can be determined from the plurality of configured ROs according to an active state of the UE at a first time, the active state comprising a first state corresponding to the first bandwidth or a second state corresponding to the second bandwidth. The UE can transmit, via a transceiver, a physical random access channel (PRACH) transmission at a second time using a selected RO of the set of valid ROs.

### INTRODUCTION

Aspects of the present disclosure generally relate to wireless communication. In some implementations, examples are described for random access channel configurations for bandwidth part (BWP) switching.

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, an apparatus for wireless communication at a user equipment (UE) is provided. The apparatus includes a processing system, and a transceiver in communication with the processing system, where the processing system is configured to: obtain configuration information indicative of a set of parameters associated with an active bandwidth part (BWP) of the UE, the configuration information corresponding to at least a first bandwidth and a second bandwidth within the active BWP, wherein one or more parameters of the set of parameters correspond to a random access channel (RACH) configuration indicative of a plurality of configured RACH occasions (ROs) within the active BWP; determine a set of valid ROs based on the configuration information and an active state of the UE at a first time, wherein the set of valid ROs includes one or more valid ROs determined from the plurality of configured ROs according to the active state of the UE, and wherein the active state of the UE comprises a first state corresponding to the first bandwidth or a second state corresponding to the second bandwidth; and transmit, via the transceiver, a physical random access channel (PRACH) transmission at a second time, the PRACH transmission using a selected RO of the set of valid ROs.

In another example, a method for wireless communication is provided, the method including: obtaining configuration information indicative of a set of parameters associated with an active bandwidth part (BWP) of the UE, the configuration information corresponding to at least a first bandwidth and a second bandwidth within the active BWP, wherein one or more parameters of the set of parameters correspond to a random access channel (RACH) configuration indicative of a plurality of configured RACH occasions (ROs) within the active BWP; determining a set of valid ROs based on the configuration information and an active state of the UE at a first time, wherein the set of valid ROs includes one or more valid ROs determined from the plurality of configured ROs according to the active state of the UE, and wherein the active state of the UE comprises a first state corresponding to the first bandwidth or a second state corresponding to the second bandwidth; and transmitting, via a transceiver of the UE, a physical random access channel (PRACH) transmission at a second time, the PRACH transmission using a selected RO of the set of valid ROs.

In another example, a non-transitory computer-readable storage medium is provided comprising instructions stored thereon which, when executed by at least one processor, causes the at least one processor to: obtain configuration information indicative of a set of parameters associated with an active bandwidth part (BWP) of the UE, the configuration information corresponding to at least a first bandwidth and a second bandwidth within the active BWP, wherein one or more parameters of the set of parameters correspond to a random access channel (RACH) configuration indicative of a plurality of configured RACH occasions (ROs) within the active BWP; determine a set of valid ROs based on the configuration information and an active state of the UE at a first time, wherein the set of valid ROs includes one or more valid ROs determined from the plurality of configured ROs according to the active state of the UE, and wherein the active state of the UE comprises a first state corresponding to the first bandwidth or a second state corresponding to the second bandwidth; and transmit, via a transceiver in communication with the at least one processor, a physical random access channel (PRACH) transmission at a second time, the PRACH transmission using a selected RO of the set of valid ROs.

In another example, an apparatus is provided for wireless communication. The apparatus includes: means for obtaining configuration information indicative of a set of parameters associated with an active bandwidth part (BWP) of the UE, the configuration information corresponding to at least a first bandwidth and a second bandwidth within the active BWP, wherein one or more parameters of the set of parameters correspond to a random access channel (RACH) configuration indicative of a plurality of configured RACH occasions (ROs) within the active BWP; means for determining a set of valid ROs based on the configuration information and an active state of the UE at a first time, wherein the set of valid ROs includes one or more valid ROs determined from the plurality of configured ROs according to the active state of the UE, and wherein the active state of the UE comprises a first state corresponding to the first bandwidth or a second state corresponding to the second bandwidth; and means for transmitting a physical random access channel (PRACH) transmission at a second time, the PRACH transmission using a selected RO of the set of valid ROs.

Aspects generally include a method, apparatus, system, computer program product, non-transitory computer-readable medium, user equipment, base station, wireless communication device, and/or processing system as substantially described herein with reference to and as illustrated by the drawings and specification. The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of physical channels and reference signals in a wireless network, in accordance with some examples;

FIG. 6 is a diagram illustrating an example switching timeline based on a switching downlink control information (DCI) and an associated switching delay time, in accordance with some examples;

FIG. 7 is a diagram illustrating an example of a subband configuration associated with multiple subbands within an active bandwidth part (BWP), where the subband configuration supports DCI designs for light adaptation between subbands of the active BWP, in accordance with some examples;

FIG. 8A is a diagram illustrating an example of first and second states corresponding to sub-BWPs within an active BWP, in accordance with some examples;

FIG. 8B is a diagram illustrating an example of a switching timeline associated with an adaptation scheme for reconfiguration of a BWP via DCI, in accordance with some examples;

FIG. 9 is a diagram illustrating an example of a switching timeline corresponding to a common random access channel (RACH) configuration associated with at least first and second sub-BWPs of an active BWP of a UE, in accordance with some examples;

FIG. 10 is a diagram illustrating an example of corresponding sets of valid ROs for a first and second sub-BWP within an active BWP of a UE that may be used for a RACH procedure, in accordance with some examples;

FIG. 11 is a diagram illustrating an example of an active BWP with at least a first and second sub-BWP, with one or more additional ROs determined within a narrower sub-BWP corresponding to the first or second sub-BWP, in accordance with some examples;

FIG. 12 is a flow diagram illustrating an example of a process for wireless communication, in accordance with some examples; and

FIG. 13 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In various wireless communication networks (e.g., 4G/LTE, 5G/NR, 6G, and beyond), a UE may support multiple bandwidth parts (BWPs) and may communicate with a network entity (e.g., base station, gNB, etc.) using an active BWP of the multiple BWPs. Each BWP of the multiple BWPs supported by the UE can be associated with a respective set of configured parameters. For example, the UE can use a first set of configured parameters for communicating via a first BWP of the multiple BWPs, and can use a second set of configured parameters for communicating via a second BWP of the multiple BWPs, etc. In some examples, one or more parameters can be configured on a per-BWP basis. Switching between BWPs may be associated with a corresponding switch between sets of configured parameters, which may involve a relatively “heavy” reconfiguration at the UE. Such a “heavy” reconfiguration may be associated with a relatively high cost at the UE to store the respective sets of configured parameters for each BWP and/or a relatively high timeline and/or reprogramming cost at the UE to reconfigure the corresponding set of configured parameters each time a BWP switch occurs.

In some examples, to mitigate relatively heavy reconfiguration costs that may be associated with BWP switches (e.g., switching between BWPs), some systems may support a light bandwidth adaptation scheme where a network entity can configure multiple subbands within a BWP, with the multiple subbands inheriting some of the parameters configured for the BWP and with each of the multiple subbands being configured with relatively smaller sets of subband-specific parameters. In accordance with each of the multiple subbands being configured with relatively smaller sets of subband-specific parameters and otherwise being associated with the same parameters as the larger BWP, switching between subbands may correspond to a relatively “light” adaptation at a UE. In some examples, the “light” adaptation may be associated with a relatively low cost at the UE to store respective sets of parameters for each subband and/or a relatively low timeline and/or reprogramming cost at the UE to reconfigure parameters each time a subband switch occurs within a BWP.

In some examples, various downlink control information (DCI) fields may be bandwidth dependent, where the bandwidth dependent DCI fields may have different sizes based on bandwidth. Bandwidth dependent DCI fields can be associated with issues of decoding and/or complexity at a UE that is configured to switch between multiple subbands within an active BWP, for example based on the multiple subbands having different respective bandwidths within the active BWP. In some cases, an adaptation scheme can implement one or more additional DCI field interpretations for DCI messages in systems that support multiple subbands within an active BWP, based on the additional DCI field interpretations supporting a universal DCI design that is decodable by a UE independent from the particular subband (e.g., of the multiple subbands within the active BWP) that is being used by a UE or network entity.

Some wireless communication systems may support an adaptation scheme that enables reconfiguration of a BWP via DCI, without impacting a DCI format. The adaptation scheme can enable fast switching between configurations for the BWP (e.g., switching configurations for a next slot). Configuration parameters of the BWP that can be adapted according to the adaptation scheme include, for example, a maximum bandwidth, a maximum rank, a minimum processing timeline, or a search space (SS) periodicity. According to the adaptation scheme, DCI can be used to indicate a state in which the UE is to operate, with the state being defined according to values of the configuration parameters. For example, the state can correspond to and/or can be indicative of a particular sub-BWP of the multiple sub-BWPs associated with an active BWP used by the UE and/or network entity. In some examples, a first state may be a “high power” state (e.g., a first sub-BWP may be a “high power” sub-BWP), and can correspond to a first (e.g., larger) maximum bandwidth, a first (e.g., larger) maximum rank, a first (e.g., shorter) minimum processing timeline, and/or a first SS periodicity. A second state may be a “low power” state (e.g., a second sub-BWP may be a “low power” sub-BWP), and can correspond to a second (e.g., smaller) bandwidth, a second (e.g., smaller) maximum rank, a second (e.g., longer) minimum processing timeline, and/or a second SS periodicity.

In some cases, the adaptation scheme may allow the UE to switch between operation in accordance with the first state (e.g., corresponding to a first set of configured parameters for a first sub-BWP of the active BWP) and operation in accordance with the second state (e.g., corresponding to a second set of configured parameters for a second sub-BWP of the active BWP) via DCI, which provides faster switching as compared to switching between BWPs. Further, such an implementation of the adaptation scheme provides UE power savings by, for example, enabling the UE to operate in the “low power” state when possible.

Systems, apparatuses, processes (also referred to as methods), and computer-readable media (collectively referred to as “systems and techniques”) are described herein that can be used to provide switching adaptation between configured subbands of an active BWP of a UE, where the switching adaptation may be associated with a random access channel (RACH) procedure performed by the UE. In some cases, the configured subbands of the active BWP of the UE may also be referred to as sub-BWPs of (e.g., within) the active BWP. For example, the switching adaptation may correspond to a DCI or other signaled trigger configured to cause a UE to switch from a first sub-BWP (e.g., a first bandwidth, first subband, etc.) within the active BWP to a second sub-BWP (e.g., a second bandwidth, second subband, etc.) within the active BWP.

In some examples, the systems and techniques can be used to implement a shared (e.g., common) configuration for each sub-BWP configured within an active BWP of a UE, where the shared configuration is a configuration for performing a RACH procedure by the UE. For example, at least a first and second sub-BWP within the active BWP of the UE can use the same common RACH or PRACH configuration to perform a PRACH transmission in response to a trigger. The trigger can be a request from a network entity to perform the RACH procedure by the UE, and/or the trigger may be determined by the UE. The systems and techniques can be used to determine one or more RACH occasions (ROs) from a configured plurality of ROs within the active BWP, where the determined one or more ROs are used by the UE to perform the PRACH transmission.

In some cases, the systems and techniques can provide RACH configurations with light adaptation between respective states corresponding to different sub-BWPs used as the UL sub-BWP within the active BWP of the UE for the PRACH transmission. In some cases, a common RACH configuration can be used across all sub-BWPs, with different validity rules per sub-BWP used to identify the particular ROs (e.g., of a plurality of configured ROs according to the common RACH configuration) that are valid and/or invalid for or within a particular sub-BWP. In some examples, a common RACH configuration can be used across sub-BWPs, and the systems and techniques may implement a switching timeline that causes a UE to switch from a first sub-BWP to a second sub-BWP for performing the PRACH transmission, where the second sub-BWP includes one or more valid ROs that would be invalid ROs had the UE not switched from the first sub-BWP to the second sub-BWP (e.g., one or more valid ROs within the second sub-BWP are invalid ROs for the first sub-BWP).

In some cases, the systems and techniques can use a shared RACH configuration across the sub-BWPs of the active BWP of the UE, and the UE may determine one or more additional ROs for a narrower bandwidth of either the first or second sub-BWP. For example, the first sub-BWP can have a narrower bandwidth than the second sub-BWP, and the UE may determine and use one or more additional ROs for the first sub-BWP as valid candidate ROs for the PRACH transmission. The one or more additional ROs can be ROs that are not included in or indicated by the set of the plurality of configured ROs determined according to the shared RACH configuration. In some examples,. The one or more additional ROs can be determined based on a modulo operation configured according to a bandwidth of the first sub-BWP (e.g., bandwidth of the sub-BWP where the additional RO(s) are configured for use with the PRACH transmission, etc.).

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, a processing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, processing system, or the like may include disclosure of the UE, base station, apparatus, device, computing system, processing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first processing system, a first one or more components, a first processing entity, or the like configured to receive the information; and the second network node may refer to a second UE, a second base station, a second apparatus, a second device, a second computing system, a second processing system, a second one or more components, a second processing entity, or the like.

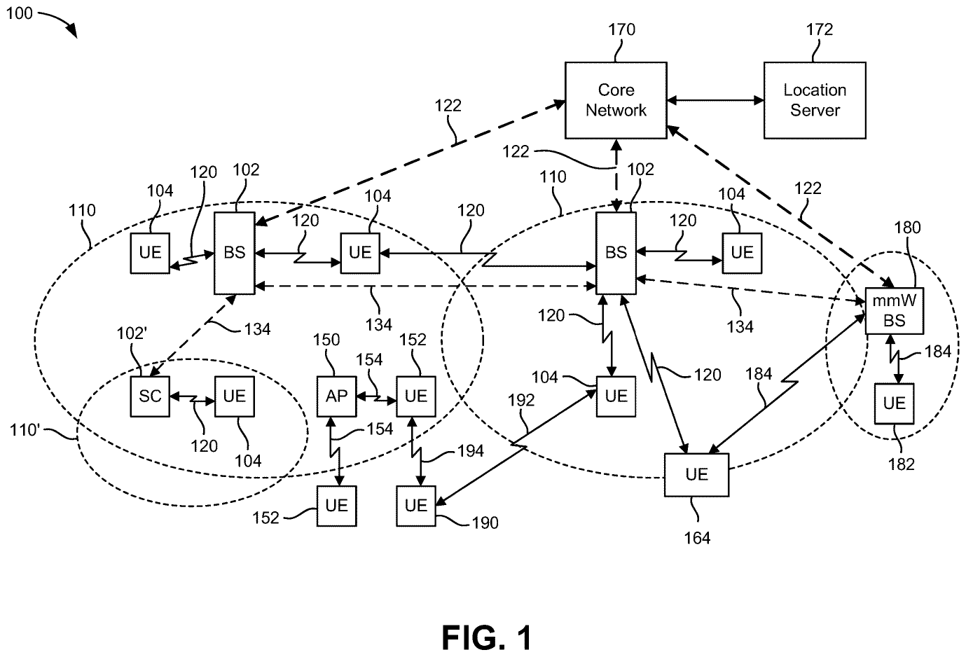

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, a processing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network of wireless communications system 100 of FIG. 1. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, network node, apparatus, device, computing system, processing system or the like may include disclosure of the UE, base station, network node, apparatus, device, computing system, processing system or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first processing system, a first set of one or more one or more components, a first processing entity, or the like configured to receive the information; and the second network entity may refer to a second UE, a second base station, a second apparatus, a second device, a second computing system, a second processing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

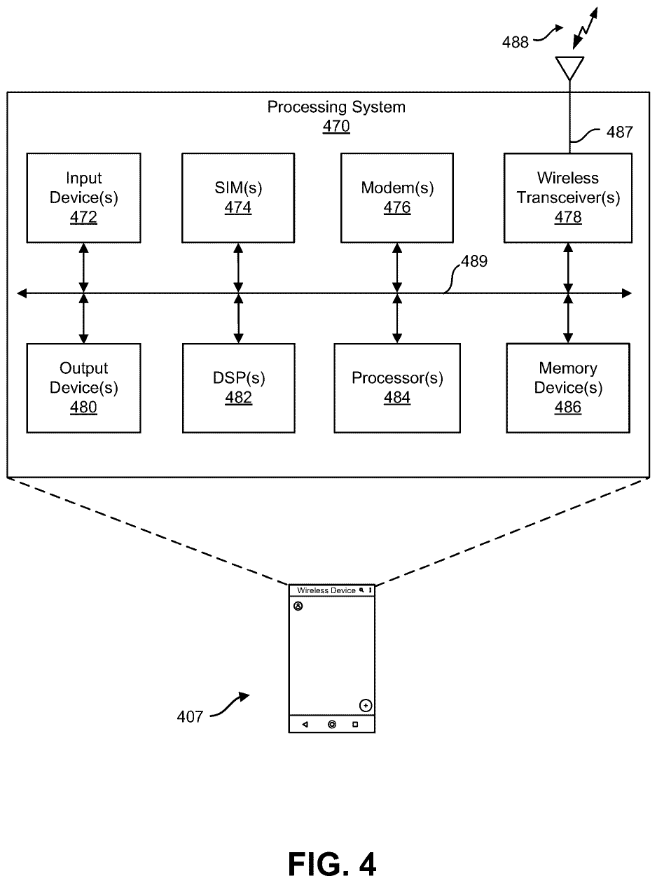

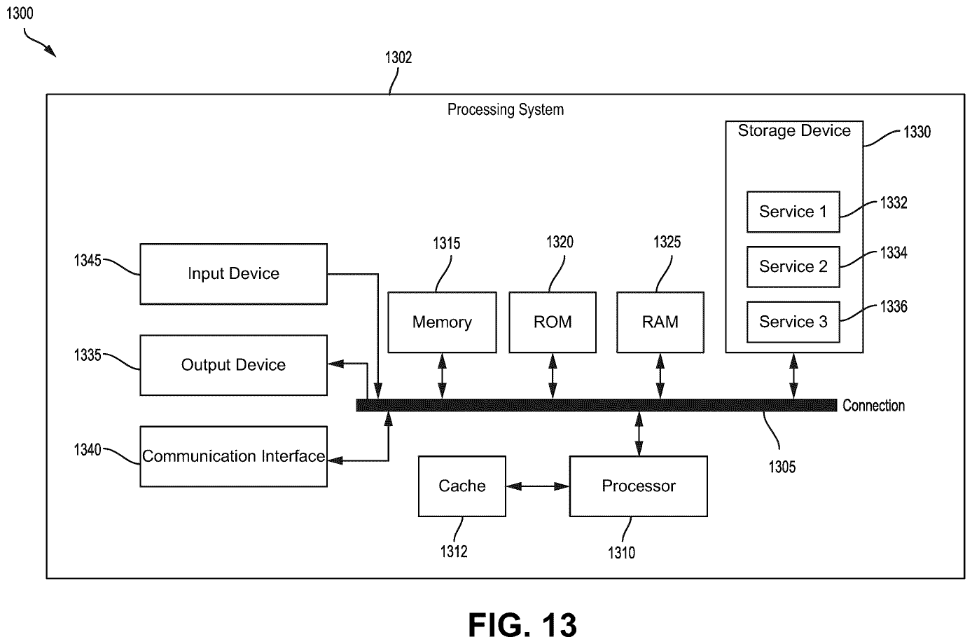

In some examples, the base station (e.g., network entity) 102 may include a processing system (e.g., such as the processing system 470 of FIG. 4 and/or the processing system 1302 of FIG. 13, etc.). Similarly, the millimeter wave (mmW) base station 180 (e.g., network entity) may include a respective processing system (e.g., such as the processing system 470 of FIG. 4 and/or the processing system 1302 of FIG. 13, etc.). A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 102 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

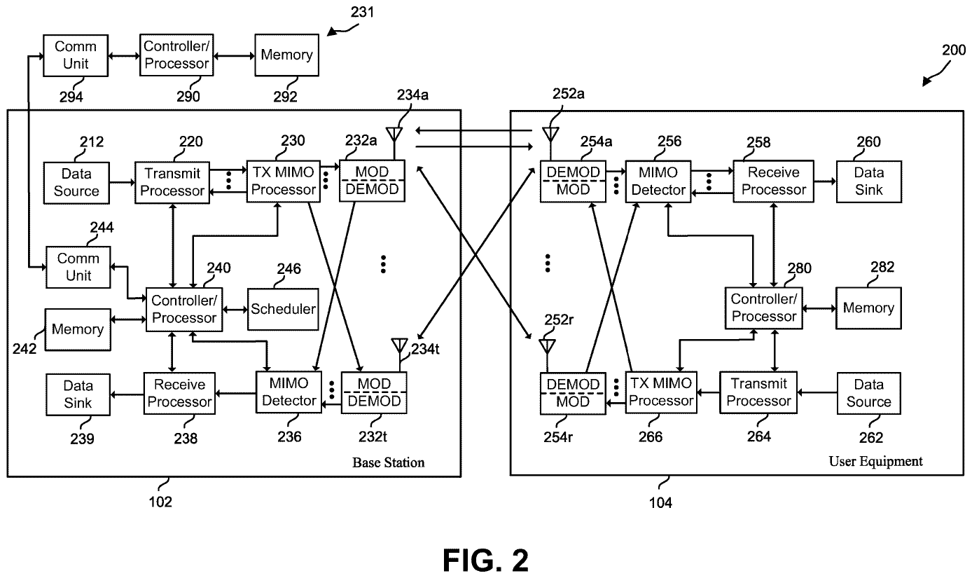

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit Uplink Control Information (UCI) beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

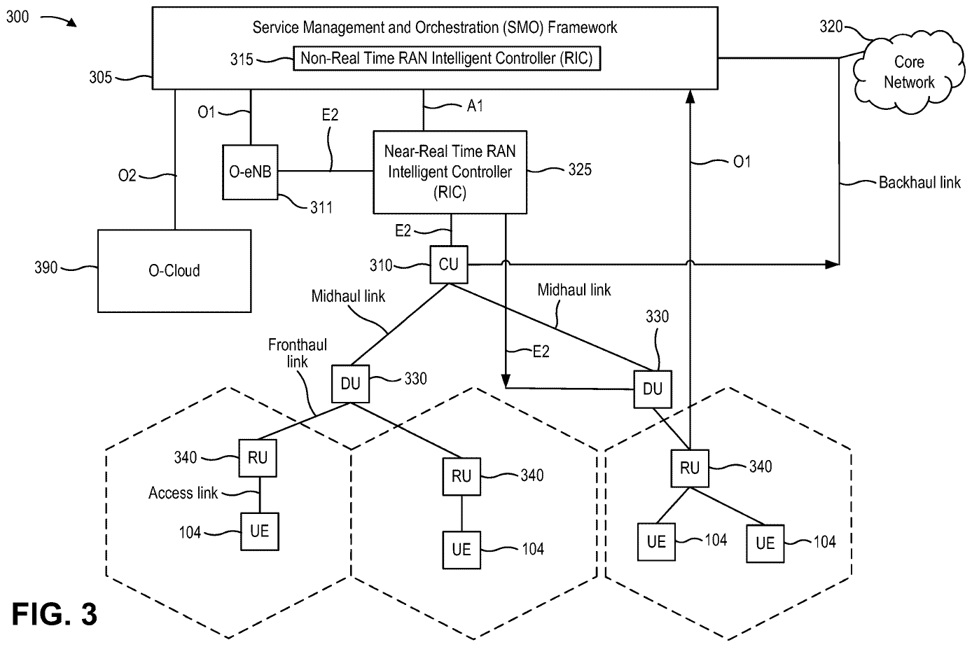

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUs 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via O1) or via creation of RAN management policies (e.g., such as A1 policies).

FIG. 4 illustrates an example of a processing system 470 of a wireless device 407. In some examples, the processing system 470 may also be referred to as a computing system. The processing system 470 may include and/or implement one or more components that are the same as or similar to respective components included in and/or implemented by the processing system 1302 of FIG. 13 (e.g., and the processing system 1302 of FIG. 13 may include and/or implement one or more components that are the same as or similar to respective components included in and/or implemented by the processing system 470 of FIG. 4). In some cases, the wireless device 407 may also be referred to as a user computing device. The wireless device 407 may include a client device such as a UE (e.g., UE 104, WLAN STA 152, UE 190) or other type of device (e.g., a station (STA) configured to communication using a Wi-Fi interface) that may be used by an end-user. In some cases, the processing system 470 of the wireless device 407 can be implemented by one or more of the UEs 104 of FIG. 1. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network.

The processing system 470 includes software and hardware components that may be electrically or communicatively coupled via a bus 489 (e.g., or may otherwise be in communication, as appropriate). The processing system 470 may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. For example, the processing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The processing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, processing system 470 may include one or more radio frequency (RF) interfaces configured to transmit and/or receive RF signals. In some examples, an RF interface may include components such as modem(s) 476, wireless transceiver(s) 478, and/or antenna(s) 487. The one or more wireless transceivers 478 may transmit and receive wireless signals (e.g., wireless signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the processing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the processing system 470 may include a coding-decoding device (or CODEC) configured to encode and/or decode data transmitted and/or received using the one or more wireless transceivers 478. In some cases, the processing system 470 may include an encryption-decryption device or component configured to encrypt and/or decrypt data (e.g., according to the Advanced Encryption Standard (AES) and/or Data Encryption Standard (DES) standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The processing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in one or more memory devices 486 and executed by the one or more processors 484 and/or the one or more DSPs 482. The processing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

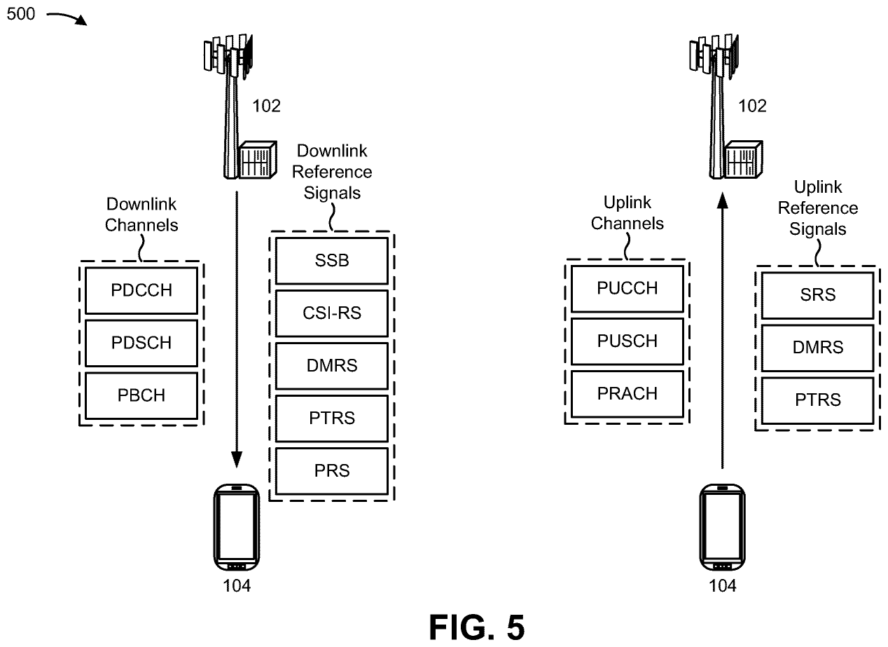

FIG. 5 is a diagram illustrating an example 500 of physical channels and reference signals in a wireless network. In some examples, one or more downlink channels and one or more downlink reference signals may carry information from a base station 102 to a UE 104. One or more uplink channels and one or more uplink reference signals may carry information from UE 104 to base station 102.

In some aspects, a downlink channel may include one or more of a physical downlink control channel (PDCCH) that carries downlink control information (DCI), a physical downlink shared channel (PDSCH) that carries downlink data, and/or a physical broadcast channel (PBCH) that carries system information, among other examples. In some aspects, PDSCH communications may be scheduled by PDCCH communications.

In some examples, an uplink channel may include one or more of a physical uplink control channel (PUCCH) that carries uplink control information (UCI), a physical uplink shared channel (PUSCH) that carries uplink data, and/or a physical random access channel (PRACH) used for initial network access, among other examples. In some aspects, UE 104 may transmit acknowledgement (ACK) or negative acknowledgement (NACK) feedback (e.g., ACK/NACK feedback or ACK/NACK information) in UCI on the PUCCH and/or the PUSCH.

In some cases, a downlink reference signal may include one or more of a synchronization signal block (SSB), a channel state information (CSI) reference signal (CSI-RS), a demodulation reference signal (DMRS), a positioning reference signal (PRS), and/or a phase tracking reference signal (PTRS), among other examples. In some examples, an uplink reference signal may include one or more of a sounding reference signal (SRS), a DMRS, and/or a PTRS, among other examples.

An SSB may carry or include information used for initial network acquisition and synchronization. For example, an SSB can carry or include one or more of a primary synchronization signal (PSS), a secondary synchronization signal (SSS), a PBCH, and/or a PBCH DMRS. An SSB may also be referred to as a synchronization signal/PBCH (SS/PBCH) block. In some aspects, base station 102 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. For example, base station 102 can configure a set of CSI-RSs for UE 104, and UE 104 can measure the configured set of CSI-RSs. Based on the CSI-RS measurements, UE 104 can perform channel estimation and report channel estimation parameters to base station 102 (e.g., in a CSI report). For example, the channel estimation parameters can include one or more of a channel quality indicator (CQI), a precoding matrix indicator (PMI), a CSI-RS resource indicator (CRI), a layer indicator (LI), a rank indicator (RI), and/or a reference signal received power (RSRP), among other examples.

In some examples, base station 102 can use the CSI report to select transmission parameters for downlink communications to UE 104. For example, base station 102 can use the CSI report to select transmission parameters that include one or more of a quantity of transmission layers (e.g., a rank), a precoding matrix (e.g., a precoder), a modulation and coding scheme (MCS), and/or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS can carry information used to compensate for oscillator phase noise. In some cases, oscillator phase noise may increase as an oscillator carrier frequency increases. In some examples, a PTRS can be utilized at high carrier frequencies (e.g., such as millimeter wave frequencies) to mitigate oscillator phase noise. The PTRS may be used to track the phase of the local oscillator and to enable suppression of phase noise and common phase error (CPE). As illustrated in FIG. 5, in some examples one or more PTRSs can be used for both downlink communications (e.g., on the PDSCH) and uplink communications (e.g., on the PUSCH).

A PRS may carry information associated with timing or ranging measurements of UE 104. For example, UE 104 may utilize one or more signals (e.g., PRSs) transmitted by base station 102 to improve an observed time difference of arrival (OTDOA) positioning performance. In some examples, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). A PRS can be designed to improve detectability by UE 104, which may need to detect downlink signals from multiple neighboring base stations in order to perform OTDOA-based positioning. Accordingly, UE 104 may receive a PRS from multiple cells (e.g., a reference cell and one or more neighbor cells), and may report a reference signal time difference (RSTD) based on OTDOA measurements associated with the PRSs received from the multiple cells. In some aspects, base station 102 can calculate a position of UE 104 based on the RSTD measurements reported by UE 104.

In some examples, an SRS can carry information used for uplink channel estimation, which may be used for scheduling, link adaptation, precoder selection, and/or beam management, among other examples. Base station 102 can configure one or more SRS resource sets for UE 104, and UE 104 can transmit SRSs on the configured SRS resource sets. An SRS resource set may have a configured usage, such as uplink CSI acquisition, downlink CSI acquisition for reciprocity-based operations, uplink beam management, among other examples. Base station 102 may measure the SRSs, may perform channel estimation based on the measurements, and/or may use the SRS measurements to configure communications with UE 104.

In some cases, a UE may receive a reference signal (e.g., a CSI-RS, an SSB, a DMRS, etc.) from a network entity (or another UE) and can report channel state feedback (CSF) to the network entity (or the other UE), where the CSF is determined based on measurements of the reference signal received at the UE. In some cases, a UE may also transmit a reference signal (e.g., CSI-RS, DMRS, PT-RS, SRS, etc.), and a network entity (or another UE) may determine characteristics associated with the channel based on measurements of the received reference signal.

As noted above, the systems and techniques can be used to provide switching adaptation between configured subbands of an active bandwidth part (BWP) of a UE, where the switching adaptation may be associated with a random access channel (RACH) procedure performed by the UE. In some cases, the configured subbands of the active BWP of the UE may also be referred to as sub-BWPs of (e.g., within) the active BWP. For example, the switching adaptation may correspond to a DCI or other signaled trigger configured to cause a UE to switch from a first sub-BWP (e.g., a first bandwidth, first subband, etc.) within the active BWP to a second sub-BWP (e.g., a second bandwidth, second subband, etc.) within the active BWP.

For example, in some cases a UE (e.g., UE 104, and/or various other UEs) may support multiple BWPs and may communicate with a network entity (e.g., base station, gNB, etc.) via an active BWP of the multiple BWPs. In some examples, the multiple BWPs may include up to four uplink BWPs and up to four downlink BWPs, although UEs described herein may support any quantity of uplink or downlink BWPs. For example, a UE may support any quantity of BWPs for communication via one or more uplink channels and may support any quantity of BWPs for communication via one or more downlink channels. Uplink channels may include a physical uplink shared channel (PUSCH), a physical uplink control channel (PUCCH), and a physical random access channel (PRACH). Downlink channels may include a physical downlink shared channel (PDSCH) and a physical downlink control channel (PDCCH). Supporting and switching between different BWPs may enable a UE to experience flexible spectrum assignment different from a carrier bandwidth. A UE may support a single active BWP, such that the UE may use one BWP as an active BWP at a time. Each of the multiple BWPs that a UE supports may be associated with a respective set of configured parameters such that, in some cases, the UE may use a first set of configured parameters in accordance with communicating via a first BWP and may use a second set of configured parameters in accordance with communicating via a second BWP.

For example, parameters associated with one or more of a bandwidth (e.g., such as 20 MHz or 100 MHz, among other examples), a subcarrier spacing (SCS), a modulation and coding scheme (MCS) table, a channel state information (CSI) configuration, a maximum rank, a control resource set (CORESET), a sounding reference signal (SRS) configuration, a configured grant (CG) configuration, semi-persistently scheduled communications, beam failure reporting parameters, and radio link management (RLM) parameters may be configured on a per-BWP basis. Such parameters may be examples of RRC parameters, which may be organized in a BWP container (e.g., such that, in some aspects, BWPs may be understood as profiles). Use of BWPs may enable adaptation of radio (e.g., such as RRC) parameters at a UE. A BWP change may occur via RRC or DCI signaling or in accordance with an expiry of a BWP inactive timer. A change in a BWP may be associated with a change in a monitored bandwidth, such as a change from 20 MHz to 100 MHz for a time period within which a relatively large amount of data is to be transmitted to a UE.

In some examples, switching between BWPs may be associated with a corresponding switch between sets of configured parameters, which may involve a relatively “heavy” reconfiguration at a UE. For example, issues may arise in some deployment scenarios because of a relatively large quantity of configurations that are BWP-dependent. Such a “heavy” reconfiguration may be associated with a relatively high cost at the UE to store the respective sets of configured parameters for each BWP or a relatively high timeline/reprogramming cost at the UE to reconfigure parameters each time a BWP switch occurs. Thus, while supporting configurations on a per-BWP basis may provide relatively greater system flexibility, having a relatively large quantity of configurations that are BWP-dependent may incur some costs in terms of complexity at a UE. For example, from a perspective of a UE, the UE may either pay a relatively higher area cost to store a complete set of configurations (such as for a complete set of BWPs) or pay a timeline cost to a reprogramming cost each time the UE switches from one BWP to another BWP. A significant portion of a time delay associated with BWP switching may be spent reconfiguring the UE with a set of parameters associated with the BWP to which the UE is switching. Such reconfiguration may include both hardware and firmware reconfiguration. Further, with BWP there may be a risk of a UE being unreachable for a duration at times when the UE moves to a wider BWP while a network entity remains in a narrow BWP, or vice versa. A UE may be unable to receive signaling (e.g., such as a DCI) from a network entity for such durations.

To mitigate such reconfiguration costs associated with BWP switches, some systems may support a light bandwidth adaptation mechanism according to which a network entity may configure multiple subbands within a BWP, with the multiple subbands inheriting some of the parameters configured for the BWP and with each of the multiple subbands being configured with relatively smaller sets of unique parameters. For example, a UE may receive first configuration information indicative of a set of parameters associated with a BWP and, as part of or within the first configuration information, second configuration information indicative of multiple subbands within the BWP. A unique parameter between the multiple subbands may include bandwidth such that, for example, a first subband may be associated with a first valid quantity of PRBs and a second subband may be associated with a second valid quantity of PRBs. A valid quantity of PRBs may correspond to or otherwise be understood as a quantity of PRBs that is usable for scheduling communications between a UE and a network entity. In accordance with such a light bandwidth adaptation mechanism, a set of baseband configurations may remain the same across the multiple subbands within an active BWP, leading to an avoidance of a “heavy” reconfiguration at a UE when the UE switches between subbands.

In accordance with each of the multiple subbands being configured with relatively smaller sets of unique parameters and otherwise being associated with the same parameters as the BWP, switching between subbands may involve a relatively “light” adaptation at a UE. Such a “light” adaptation may be associated with a relatively low cost at the UE to store respective sets of parameters for each subband or a relatively low timeline/reprogramming cost at the UE to reconfigure parameters each time a subband switch occurs. For example, in accordance with switching between subbands within an active BWP (e.g., such as adapting the bandwidth in accordance with the configuration of subbands and subband identifiers (IDs) within the active BWP), the UE may reconfigure a relatively smaller quantity of parameters as compared to how many parameters the UE may reconfigure in accordance with switching between BWPs, which may result in less down time per UE and reduce penalties associated with a misalignment between a UE and a network entity.

In some implementations, a UE and a network entity may support one or more signaling-or configuration-based mechanisms according to which the UE and the network entity are able to use a universal DCI design across various subbands within an active BWP (e.g., regardless of a particular subband(s) within which the UE and/or the network entity operates). In such implementations, the UE and the network entity may use or expect a size of one or more fields within a DCI message that is independent of the different valid quantities of PRBs of the multiple subbands within the active BWP. For example, a DCI message may include a field indicative of an FDRA (e.g., such as a FDRA or resource indication value (RIV) field) and, instead of a size of the field being dependent on a quantity of valid PRBs associated with a subband at which the network entity operates, the size of the field may be the same across the multiple subbands within the active BWP. A DCI design (e.g., across one or multiple DCI formats) may remain according to a size and configuration of the active BWP.

In accordance with maintaining a same size for the field indicative of the FDRA across the multiple subbands within the active BWP, the UE and the network entity may support different interpretations of the field dependent on at which subband the UE and the network entity operate. For example, the UE and the network entity may use a first interpretation of the field indicative of the FDRA in accordance with operating at the first subband (e.g., associated with the first valid quantity of PRBs) and may use a second interpretation of the field indicative of the FDRA in accordance with operating at the second subband (e.g., associated with the second valid quantity of PRBs). By supporting different interpretations depending on at which subband the UE and the network entity operate, the UE and the network entity may facilitate greater DCI decoding speed, accuracy, and/or performance, etc., and lower device complexity, which may increase a reliability of communications and reduce device power consumption.

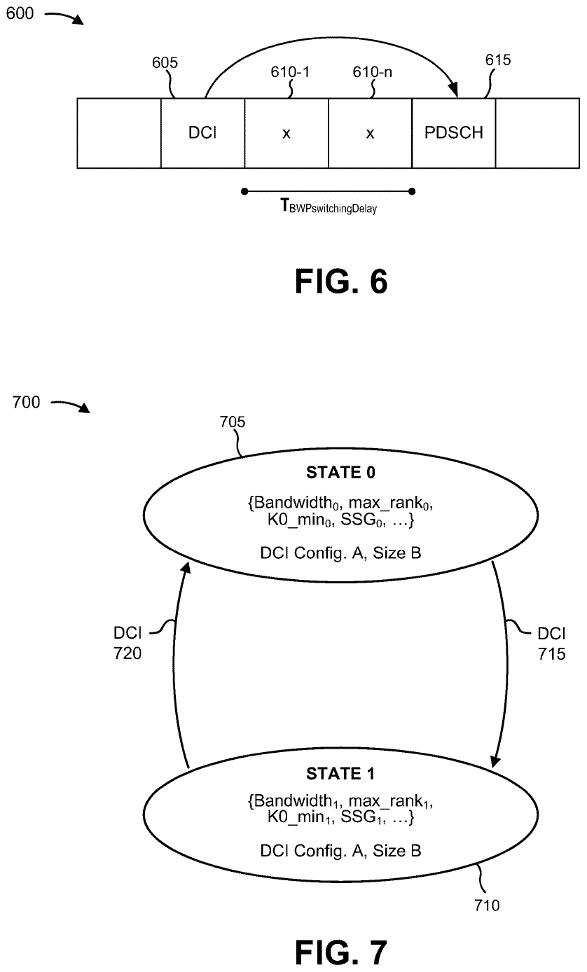

As noted above, a time delay can be associated with BWP switching, where the time delay is used for at least reconfiguring the UE with updated parameters associated with the BWP to which the UE is switching. The UE reconfiguration of parameters for BWP switching can include hardware and/or firmware reconfigurations performed by the UE. For example, FIG. 6 is a diagram illustrating an example switching timeline 600 that may be associated with BWP switching with a time delay at a UE. In one illustrative example, the BWP switching time delay can correspond to the T_{BWPswitchingDelay} illustrated in the example switching timeline 600, where the BWP switching time delay T_{BWPswitchingDelay} extends from a DCI 605 received by the UE (e.g., a switching DCI indicative of the BWP switch for the UE, etc.) and a next PDSCH that is T_{BWPswitchingDelay} slots later, after the BWP switching DCI 605. For example, as illustrated in the example switching timeline 600, the BWP switching time delay T_{BWPswitchingDelay} includes the two slots 610-1 and 610-n after the BWP switching DCI 605 and before the next PDSCH 615 for the UE. In some cases, the BWP switch time delay (e.g., T_{BWPswitchingDelay}) can be based on a UE capability and/or an SCS. In some cases, for an NR slot length of 1 ms, T_{BWPswitchingDelay} may be between one and three slots. In some examples, for an NR slot length of 0.5 ms, T_{BWPswitchingDelay} may be between two and five slots. In some examples, for an NR slot length of 0.25 ms, T_{BWPswitchingDelay} may be between three and nine slots. In another example, for an NR slot length of 0.125 ms, T_{BWPswitchingDelay} may be between six and 18 slots, etc.

FIG. 7 is a diagram illustrating an example of a subband configuration 700 associated with multiple subbands within an active BWP, where the subband configuration supports DCI designs for light adaptation between subbands of the active BWP, in accordance with some examples. The subband configuration 700 can include a first state 705 (e.g., “STATE 0”) corresponding to a first subband (e.g., first sub-BWP, also referred to as a sub-BWP 0) within an active BWP for a UE. The subband configuration 700 can include a second state 710 (e.g., “STATE 1”) corresponding to a. second subband (e.g., second sub-BWP, also referred to as a sub-BWP 1) within the active BWP for the UE. The first state 705 and the second state 710 may be associated with a set of parameters shared across an active BWP of the UE, where the active BWP is a BWP that includes at least the first sub-BWP corresponding to the first state 705 and the second sub-BWP corresponding to the second state 710. In some examples, the first state 705 and the second state 710 may be associated with unique and/or smaller sets of parameters that are subband-specific. Such smaller sets of parameters that are subband-specific may include one or more of a (maximum) rank, a quantity of operated antennas (such as a quantity of active receive (Rx) or transmit (Tx) antennas), timeline parameters (such as a K0 minimum, which may be understood as a minimum scheduling offset), a search space set group (such as a search space periodicity, such as to replace search space set group switching without a possibility of changing CORESET), and a bandwidth, among other examples.

For example, the first state 705 corresponding to the first sub-BWP 0 may be associated with one or more of a first rank (e.g., max_rank₀), a first quantity of operated antennas, a first K0 minimum (e.g., K0_min₀), a first search space set group (e.g., SSG₀), and a first bandwidth (e.g., bandwidth₀). In some cases, the first bandwidth (e.g., bandwidth₀) corresponding to the first state 705 and the first sub-BWP 0 can comprise a first valid quantity of PRBs within the active BWP of the UE. The second state 710 corresponding to the second sub-BWP 1 may be associated with one or more of a second rank (e.g., max_rank₁), a second quantity of operated antennas, a second K0 minimum (e.g., K0_min₁), a second search space set group (e.g., SSG₁), and a second bandwidth (e.g., bandwidth₁). In some cases, the second bandwidth (e.g., bandwidth₁) corresponding to the second state 710 and the second sub-BWP 1 can comprise a second valid quantity of PRBs within the active BWP of the UE, where the second valid quantity of PRBS is different from the first valid quantity of PRBs (e.g., the first bandwidth, bandwidth₀, is different from the second bandwidth, bandwidth₁, with both bandwidths being within the active BWP of the UE).

In some aspects, the first state 705 (which may be equivalently referred to herein as a first bandwidth or a first sub-BWP (e.g., sub-BWP 0) of a BWP) may be associated with a first communication configuration (such as a first state or mode) and the second state 710 (which may be equivalently referred to herein as a second bandwidth or a second sub-BWP (e.g., sub-BWP 1) of a BWP) may be associated with a second communication configuration (such as a second state or mode). The first communication configuration may be associated with, indicate, define, or specify a first maximum bandwidth, a first minimum processing timeline, a first minimum scheduling offset, and/or a first maximum rank. The second communication configuration may be associated with, indicate, define, or specify a second maximum bandwidth, a second minimum processing timeline, a second minimum scheduling offset, and/or a second maximum rank.

In examples in which the first state 705 corresponds to a first sub-BWP 0 that includes a relatively smaller valid quantity of PRBs as compared to the second state 710 corresponding to the second sub-BWP 1 quantity of PRBs, the first maximum bandwidth may be smaller than the second maximum bandwidth, the first minimum processing timeline may be longer than the second minimum processing timeline, the first minimum scheduling offset may be longer than the second minimum scheduling offset, or the first maximum rank may be relatively smaller than the second maximum rank. In some examples, the UE may switch between operation using the first sub-BWP 0 in accordance with the first communication configuration of the first state 705, and operation using the second sub-BWP 1 in accordance with the second communication configuration of the second state 710, more quickly than switching the active BWP between the multiple BWPs available for the UE.

In some cases, the UE and the network entity may support a subband switch trigger such as a switching DCI 715 to switch from the first state 705 to the second state 710 and may support a switching DCI 720 to switch from the second state 710 to the first state 705. Such switching triggers may be one or more of DCI-based, timer-based, or event-based, among other examples. In some aspects, subband switching may be accompanied with a scheduling delay, such that K0/K2 is greater than 0. Same slot scheduling may be possible according to active adaptation parameters (such as adaptation between subband-specific parameters).

In some examples, a DCI message (e.g., including one or more of the switching DCIs 715 and/or 720, etc.) may remain unchanged through adaptation between different subbands within an active BWP. For example, the first state 705 and first sub-BWP 0, and the second state 710 and second sub-BWP 1, may each be associated with a same DCI configuration and a same DIC size, illustrated in FIG. 7 as the same DCI Config. A, Size B for both the first state 705 and the second state 710. In some aspects, based on the DCI remaining unchanged throughout adaptation and switching between first state 705 and second state 710 (e.g., switching between first and second sub-BWPs 0 and 1), the UE may still be able to decode DCI messages even in scenarios in which the UE and the network entity are misaligned (e.g., out of synchronization (OOS)) regarding at which subband to operate. Further, in such implementations, unchanged DCI messages through adaptation between different subbands may reduce an amount of reprogramming that the UE performs to reconcile a misalignment or lack of synchronization regarding at which subband to operate.

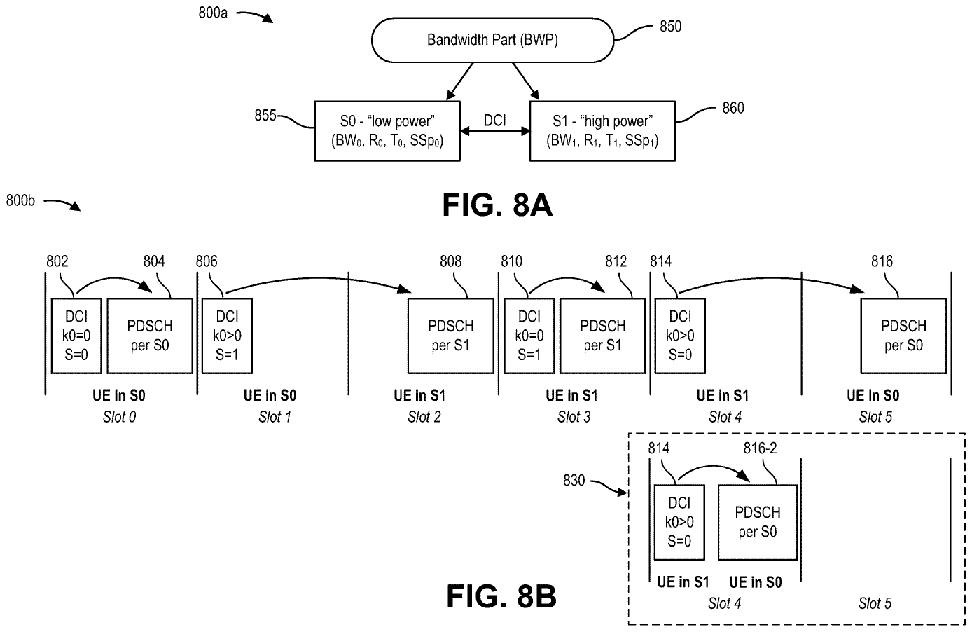

FIG. 8A is a diagram illustrating an example of a configuration 800a for an active BWP 850 with at least two sub-BWPs corresponding to a respective at least two states. For example, the configuration 800a can be a sub-BWP configuration for the active BWP 850, with a first state S0 855 corresponding to a low power state and a first sub-BWP 0 using a first bandwidth (e.g., BW₀) within the active BWP 850, and with a second state S1 860 corresponding to a relatively high power state and a second sub-BWP 1 using a second bandwidth (e.g., BW₁) within the active BWP 850. In some aspects, the first state S0 855 can correspond to and/or may be the same as or similar to the first state (e.g., State 0) 705 of FIG. 7. In some cases, the second state S1 860 can correspond to and/or may be the same as or similar to the second state (e.g., State 1) 710 of FIG. 7. Switching between state S0 855 and state S1 860 can be performed using a DCI, which may be a switching DCI the same as or similar to one or more of the switching DCI 715 and/or the switching DCI 720 of FIG. 7, etc.

FIG. 8B is a diagram illustrating an example of a switching timeline 800b associated with an adaptation scheme for reconfiguration of a BWP via DCI, in accordance with some examples. In some aspects, the switching timeline 800b may be associated with an adaptation scheme that enables reconfiguration of a BWP via DCI (e.g., light adaptation, etc.).

In the example switching timeline 800b of FIG. 8B, various communications of DCI are used for adaptive configuration of a BWP via the communicated DCI(s). For example, a UE may be capable of operating in a state S0 or a state S1 with respect to communication on a BWP. As shown, the state S0 corresponds to a “low power” state, and can be the same as the state S0 855 of FIG. 8A and/or the State 0 705 of FIG. 7, etc. The state S0 may be associated with a first set of configuration parameters (e.g., a maximum bandwidth BW₀, a maximum rank R₀, a minimum processing timeline T₀, and/or a maximum SS periodicity SSp₀, etc.). The state S1 corresponds to a “high power” state, and can be the same as the state S1 860 of FIG. 8A and/or the State 1 of 710 of FIG. 7, etc. The state S1 may be associated with a second set of configuration parameters (e.g., a maximum bandwidth BW₁, a maximum rank R₁, a minimum processing timeline T₁, and/or a maximum SS periodicity SSp₁, etc.).

As shown, in slot 0, the UE is operating in the state S0 (e.g., according to the set of configuration parameters associated with the state S0) and receives DCI 802. The DCI 802 indicates that the UE is to operate in the state S0 and schedules a PDSCH communication 804 in slot 0 (e.g., in a same slot in which the DCI 802 is received). The UE continues operation in the state S0 and receives the PDSCH communication 804 according to the set of configuration parameters associated with the state S0.

As further shown, in slot 1, the UE is operating in the state S0 and receives DCI 806. The DCI 806 indicates that the UE is to operate in the state S1 and schedules a PDSCH communication 808 in slot 2 (e.g., a next slot). After receiving the DCI 806, the UE switches to operation in the state S1 (e.g., according to the set of configuration parameters associated with the state S1) such that the UE is operating in the state S1 in slot 2. The UE receives the PDSCH communication 808 in slot 2 while operating according to the set of configuration parameters associated with the state S1.

As shown, in slot 3, the UE is operating in the state S1 and receives DCI 810. The DCI 810 indicates that the UE is to operate in the state S1 and schedules a PDSCH communication 812 in slot 3 (e.g., in a same slot in which the DCI 810 is received). The UE continues operation in the state S1 and receives the PDSCH communication 812 according to the set of configuration parameters associated with the state S1.

As further shown, in slot 4, the UE is operating in the state S1 and receives DCI 814. The DCI 814 indicates that the UE is to operate in the state S0 and schedules a PDSCH communication 816 in slot 5 (e.g., a next slot). After receiving the DCI 814, the UE switches to operation in the state S0 such that the UE is operating in the state S0 in slot 5. The UE receives the PDSCH communication 816 in slot 5 while operating according to the set of configuration parameters associated with the state S0.

In some cases, as illustrated in the example timeline 830 of slots 4 and 5, the UE may be in slot 4 and operating in the state S1 when the UE receives the DCI 814, where the DCI 814 is indicative of a BWP switch to the state S0. In the example timeline 830, the UE may perform the switch from the state S1 to the state S0 while the UE remains within slot 4. For example, the UE can receive the DCI 814 indicative of the switch and can implement the switch to state S0 (e.g., according to DCI 814), during slot 4. After the UE performs the switch to the state S0, which may be a subset of the state S1, the UE may receive a PDSCH communication 816-2 also in slot 4 (e.g., the same slot), where the PDSCH communication 816-2 is scheduled by the DCI 814 indicative of the BWP switch earlier in slot 4. In the example timeline 830, the UE is in state S0 during slot 5.

As noted above, a UE may implement an adaptation scheme for switching between subbands (e.g., sub-BWPs) within an active BWP without a corresponding change in DCI configuration and/or DCI size between the different sub-BWPs and/or states configured for the active BWP of the UE. In some cases, the systems and techniques described herein may be used to perform light adaptation for switching between subbands and/or sub-BWPs of an active BWP of the UE in association with a RACH configuration and/or RACH procedure associated with the UE. For example, RACH is a logical channel used to request uplink resources from a network entity (e.g., base station, gNB, etc.) when the UE does not have a dedicated uplink grant. A UE may initiate a RACH procedure to perform one or more of initial access, uplink synchronization, beam failure recovery, and/or handover, etc. PRACH is a PHY-level (e.g., physical layer) implementation of RACH. A PRACH transmission may carry a preamble sequence that can be used by the UE to signal an intention to connect or reconnect. PRACH may include or carry preamble formats that can vary based on deployment scenario and/or deployment configurations, etc. PRACH is transmitted on dedicated time-frequency resources configured by the network (e.g., network entity, base station, gNB, etc.).

In some examples, a PDCCH order can be used for random access triggering (e.g., at the UE) by the network entity. For example, a PDCCH order can cause the UE to initiate a RACH procedure, including in scenarios such as beam failure recovery and/or on-demand UL scheduling and/or various other scenarios where a UE is not uplink synchronized with the network, etc. PDCCH order can be transmitted by a network entity using DCI format 1_0 with CRC masking, where CRC is scrambled with the C-RNTI of the target UE. The target UE can receive the DCI format 1_0 and may determine that the received DCI format 1_0 corresponds to a PDCCH order based on the FDRA field of the DCI being set to values of all ‘1’s, in which case the DCI is indicative of a random access (RA) preamble index (e.g., carried on 6 bits), an UL/SUL indication (e.g., carried on 1 bit), an SSB index (e.g., carried on 6 bits), and/or a PRACH mask index (e.g., carried on 4 bits), with the remaining bits reserved.

In some cases, the RA preamble index may be 6 bits, and if the RA preamble index is 0, then the UE may determine a PDCCH order triggering a contention-based random access (CBRA) procedure, and the UE may ignore the remaining fields of the DCI in response to the RA preamble index of 0 triggering CBRA. If the RA preamble index is not 0, then the UE may determine a PDCCH order triggering contention-free random access (CFRA). In some examples, when CFRA is triggered (e.g., RA preamble index of the DCI is not 0) the UE performs the RACH procedure by transmitting the PRACH in an indicated RACH occasion (RO). In examples where CBRA is triggered (e.g., RA preamble index of the DCI is 0), the UE performs the RACH procedure by transmitting the PRACH in a RACH occasion that is determined for and/or associated with a measured SSB of the CBRA procedure. After PRACH transmission on a valid RO, the UE monitors PDCCH with CRC scrambled with RA-RNTI (DCI format 1-0), which schedules the RAR PDSCH. When the CFRA is on the primary cell (PCell) or primary secondary cell (PSCell), the UE may be configured to assume the PDCCH with RA-RNTI is quasi co-located (QCL'ed) with the PDCCH order. The UE may also assume that the RAR PDSCH is QCL'ed with PDCCH order.

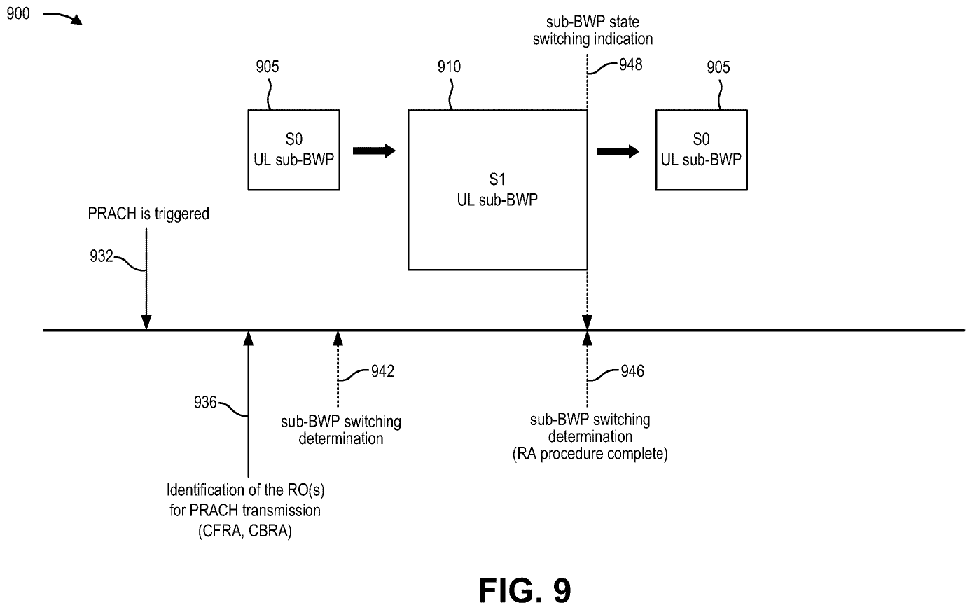

FIG. 9 is a diagram illustrating an example of a switching timeline 900 corresponding to a common random access channel (RACH) configuration associated with at least first and second sub-BWPs of an active BWP of a UE, in accordance with some examples. For example, the common RACH configuration can be included in and/or indicated by configuration information associated with the adaptation for BWP switching between the different sub-BWPs (e.g., and the corresponding bandwidth and state associated with each sub-BWP of the at least two sub-BWPs configured within an active BWP of a UE). In some cases, a UE can obtain configuration information indicative of a set of parameters associated with the active BWP for or of the UE, where the configuration information corresponds to at least a first bandwidth for a first sub-BWP (e.g., sub-BWP 0) associated with a first state (e.g., S0) of the light adaptation configuration, and at least a second bandwidth for a second sub-BWP (e.g., sub-BWP 1) associated with a second state (e.g., S1) of the light adaptation configuration.

One or more parameters of the configuration information correspond to the RACH configuration, and in one illustrative example can be indicative of a plurality of configured RACH occasions (ROs) within the active BWP. The plurality of configured ROs can be ROs on time-frequency resources configured by the network and that can be used for a RACH procedure and/or corresponding PRACH transmission by the UE performing the RACH procedure.

For example, a UE may be associated with an active BWP configured with at least two sub-BWPs (e.g., a first sub-BWP 0 corresponding to state S0 705 of FIG. 7, state S0 855 of FIG. 8A, and/or state S0 of the switching timeline 800b of FIG. 8B, etc.; and a second sub-BWP 1 corresponding to state S1 710 of FIG. 7, state S1 860 of FIG. 8A, and/or state S1 of the switching timeline 800b of FIG. 8B, etc.). The sub-BWP configuration includes at least the sub-BWP 0 and sub-BWP 1, corresponding to a state S0 and a state S1, respectively, where in the first sub-BWP 0 and corresponding state S0, the UE is configured to assume no scheduling beyond a first bandwidth (e.g., the bandwidth BW₀ of the first sub-BWP 0). A second bandwidth is larger (e.g., wider) than the first bandwidth, and can be the bandwidth BW₁ of the second sub-BWP 1, where BW₁ >BW₀. For example, the first sub-BWP 0 can be a low-power state S0 sub-BWP, with a bandwidth of 20 MHz (e.g., within a 100 MHz bandwidth of an active BWP of the UE). The second sub-BWP 1 can be a high-power (e.g., higher-power) state S1 sub-BWP, with a bandwidth of ~100 MHz. In some cases, the second sub-BWP 1 includes the first sub-BWP 0. In some examples, the second sub-BWP 1 is equal to the active BWP. In some examples, the second sub-BWP 1 is a subset of the active BWP.

Based on the light adaptation BWP switching configuration for switching between the low-power state S0 sub-BWP 0 and the high-power (e.g., higher-power) state S1 sub-BWP 1, the UE can receive and/or use BWP switching DCIs with the DCI sizes remaining the same between the states S0 and S1, and the sub-BWP 0 and sub-BWP 1. In some cases, the active BWP is associated with a configured plurality of ROs for PRACH transmission. A first portion or subset of ROs of the configured plurality of ROS can be within the first bandwidth of the first sub-BWP 0, and a second portion or subset of ROs of the configured plurality of ROs can be within the second bandwidth of the second sub-BWP 1. A configured RO of the plurality of ROs for PRACH transmission within the active BWP may be included within the first sub-BWP 0 and the second sub-BWP′. One or more of the configured ROs of the plurality of ROs for PRACH transmission within the active BWP may be included in the second sub-BWP 1, but not included within the first sub-BWP 0. In some aspects, at least a portion of (e.g., some) PDCCH MOs may remain the same between the first and second sub-BWPs for states S0 and S1, respectively.

The RACH configuration information can be used to determine a set of valid ROs based on the configuration information and an active state of the UE at a time corresponding to a PRACH trigger (e.g., PRACH trigger 932 in the example switching timeline 900) and/or an active state of the UE at a time corresponding to PRACH transmission for performing the RACH procedure (e.g., after the PRACH trigger 932).

As noted above, the UE may determine the PRACH is triggered based on the PRACH trigger 932 comprising a PDCCH order from a network entity indicative of a request for the UE to perform the RACH procedure. For example, the PRACH trigger 932 can comprise the UE receiving DCI format 1_0 with C-RNTI, where the UE determines the DCI corresponds to a PDCCH order based on the FDRRA field of the DCI being set to all ‘1’s, and where an RA preamble index value indicates CBRA or CFRA. In response to determining the PRACH trigger 932, the UE can identify (shown as identification 936), or otherwise determine, one or more ROs for PRACH transmission, using a corresponding CBRA procedure or CFRA procedure, according to the PRACH trigger 932.

The one or more ROs identified (at identification 936) by the UE can comprise a set of valid ROs determined from the plurality of configured ROs within the active BWP. The set of calid ROs may be a subset of the plurality of configured ROs within the active BWP. For example, the switching timeline 900 configuration of FIG. 9 can use a validity rule for determining the RO(s) for PRACH transmission in response to a PRACH trigger 932 by PDCCH order or by a higher layer, where the validity rule is based on the UL-BWP that will be used for the PRACH transmission. For example, if the UE is in the low-power state S0 (e.g., for example a 20 MHz bandwidth within a 100 MHz active BWP, etc.) at the time of PRACH transmission, the UL-BWP for the PRACH transmission is the 20 MHz bandwidth of the first sub-BWP 0 corresponding to state S0. If the UE is in the high-power (e.g., higher-power) state S1 (e.g., for example a 100 MHz bandwidth within (e.g., the same as) the 100 MHz active BWP, etc.) at the time of PRACH transmission, the UL-BWP for the PRACH transmission is the 100 MHz bandwidth of the second sub-BWP 1 corresponding to state S1. The switching timeline 900 can use a validity rule based on identifying valid ROs as the configured ROs that are within the bandwidth of the active UL-BWP that will be used for the PRACH transmission.

In some cases, based on the low-power state S0 having a smaller bandwidth (e.g., 20 MHz) than the high-power (e.g., higher-power) state S1 (e.g., 100 MHz), one or more of the plurality of configured ROs for PRACH transmission may be included in the S1 sub-BWP 1, but not included in the S0 sub-BWP 0 (e.g., are within the S1 sub-BWP 1, but outside of (e.g., not within) the S 0 sub-BWP 0). In some cases, a majority of ROs of the plurality of configured ROs for PRACH transmission may be included in the S1 sub-BWP 1, but not included in the S0 sub-BWP 0.

In cases where the UE determines or receives the PRACH trigger 932, and identifies an initial set of valid ROs (at identification 936) corresponding to the UE being in the S0 UL sub-BWP 905, the UE may determine a sub-BWP switching determination 942 prior to the PRACH transmission responsive to the PRACH trigger 932. For example, if the identified ROs (determined at identification 936) corresponding to the current S0 UL sub-BWP 905 configured at the time of the identification 936 are a subset and/or a minority of the plurality of configured ROs within the active BWP, the sub-BWP switching determination 942 can cause the UE to switch from the low-power S0 sub-BWP (e.g., 20 MHz) to the high-power (e.g., higher-power) S1 sub-BWP (e.g., 100 MHz) that includes one or more configured ROs that are not included in sub-BWP 0.

For example, before PRACH transmission responsive to the PRACH trigger 932, the UE can switch from the S0 UL sub-BWP 905 to the S1 UL sub-BWP 910, which is a larger (e.g., wider) bandwidth including more configured ROs (e.g., out of the plurality of configured ROs within the active BWP that includes both the S0 sub-BWP and the S1 sub-BWP). The UE can perform the PRACH transmission using the S1 UL sub-BWP 910, for example using a selected one or more valid ROs that are within the bandwidth of the S1 UL sub-BWP 910.

After the PRACH transmission and/or RACH procedure triggered by the PRACH trigger 932 is completed, the UE may be configured to automatically switch back to the low-power S0 state and corresponding S0 UL sub-BWP 905. For example, the UE may automatically determine a sub-BWP switching determination 946 in response to the RA procedure completion and/or the completion of the PRACH transmission using the S1 UL sub-BWP 910. The UE determination of the sub-BWP switching determination 946 can cause the UE to switch from the S1 UL sub-BWP 910 back to the S0 UL sub-BWP 905.

In some aspects, the UE may remain in the S1 UL sub-BWP 910 after PRACH transmission and/or the RACH procedure are completed, and the UE may be triggered to switch back to the low-power S0 UL sub-BWP 905 in response to receiving a sub-BWP state switching indication 948 from a network entity. For example, the UE may receive a DCI from the network entity where the DCI indicates the sub-BWP state switching indication from S1 UL sub-BWP 910 to S0 UL sub-BWP 905. The sub-BWP state switching indication 948 may be received from the network entity, or may be not received. In some cases, the sub-BWP state switching indication 948 may be received from the network entity in response to a determination the RA procedure has completed. In some examples, the sub-BWP state switching indication 948 may be received from the network entity separately from RA procedure completion.

In some aspects, the UE may identify, at identification 936, the RO(s) for PRACH transmission, where the identified RO(s) are within the current S0 UL sub-BWP 905 of the UE. In this example, the UE can be configured to perform the RACH procedure and PRACH transmission without switching states and without switching sub-BWPs.

In one illustrative example, a common RACH configuration can be used across all sub-BWPs configured for the active BWP of the UE, with different validity rules per sub-BWP used to identify the particular ROs (e.g., of a plurality of configured ROs according to the common RACH configuration) that are valid and/or invalid for or within a particular sub-BWP. In some examples, a common RACH configuration can be used across sub-BWPs, and the systems and techniques may implement a switching timeline (e.g., switching timeline 900 of FIG. 9, etc.) that causes a UE to switch from a first UL sub-BWP 905 to a second UL sub-BWP 910 for performing the PRACH transmission, where the second sub-BWP 910 includes one or more valid ROs that would be invalid ROs had the UE not switched from the first UL sub-BWP 905 to the second UL sub-BWP 910 (e.g., one or more valid ROs within the second UL sub-BWP 910 are invalid ROs for the first UL sub-BWP 905).

In some aspects, the UE can determine valid and/or invalid ROs of the plurality of configured ROs, where the validity determination of the configured ROs is performed on a per sub-BWP basis. For example, the UE can determine the calid and/or invalid ROs for the S0 or S1 UL sub-BWP, based on the UE determining which configured ROs of the active BWP are within the S0 UL sub-BWP, or which configured ROs are within the S1 UL sub-BWP, respectively. ROs outside of (e.g., not within) the bandwidth of an UL sub-BWP are identified as invalid ROs for that UL sub-BWP.

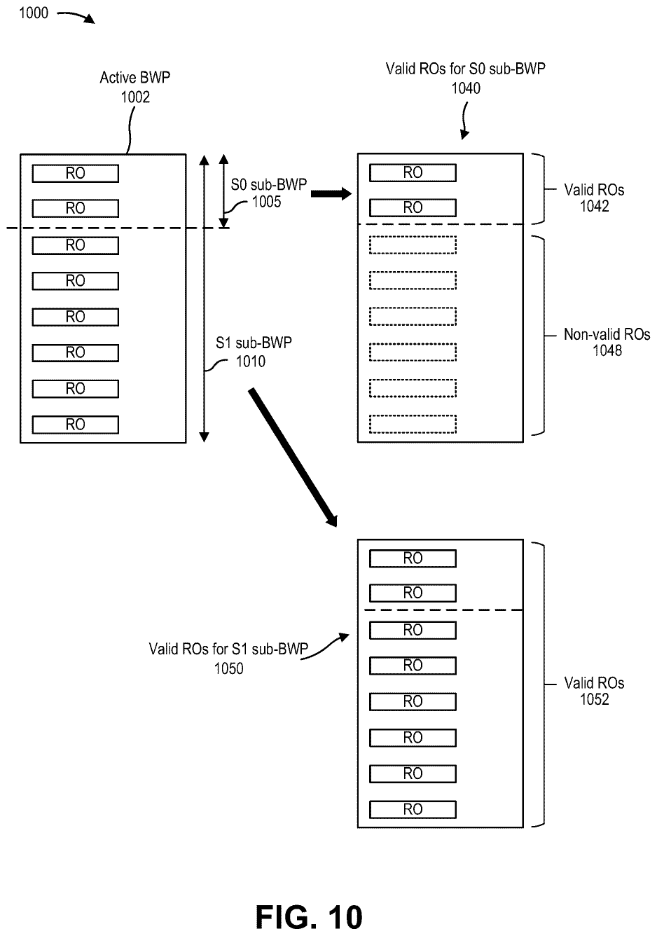

For example, FIG. 10 is a diagram illustrating an example configuration 1000 of RO validity determinations corresponding to identified sets of valid ROs for a first and second sub-BWP within an active BWP 1002 of a UE that may be used for a RACH procedure, in accordance with some examples. In some aspects, the active BWP 1002 is configured with a first sub-BWP 1005 corresponding to a low-power state S0 (e.g., S0 sub-BWP 1005) and a second sub-BWP 1010 corresponding to a high-power (e.g., higher-power) state S1 (e.g., S1 sub-BWP 1010). In some cases, the S0 sub-BWP 1005 can correspond to and/or can be the same as or similar to the S0 UL sub-BWP 905 of FIG. 9, etc. In some cases, the S1 sub-BWP 1010 can correspond to and/or can be the same as or similar to the S1 UL sub-BWP 910 of FIG. 9, etc. In some aspects, the RACH configuration for the light adaptation BWP switching between the configured sub-BWPs within the active BWP of the UE can indicate a validity rule-based RACH procedure with no switching enabled between states and sub-BWPs.

For example, the UE can determine or identify the set of valid ROs (determined at identification 936) of FIG. 9 by identifying the subset of ROs within the plurality of configured ROs for the active BWP 1002 that are included within the bandwidth of the current (e.g., active) sub-BWP bandwidth. Based on the current (e.g., active) sub-BWP being set to the low-power state S0 sub-BWP 1005, the UE may determine the set of valid ROs (determined at identification 936) as the subset of ROs within the active BWP 1002 that are also within the S0 sub-BWP 1005 (e.g., the top two ROs of the eight total ROs within the active BWP 1002 in the example of FIG. 10, etc.). The validity rule determination 1040 of the set of valid ROs 1042 for the S0 sub-BWP 1005 is illustrated in FIG. 10 as including the first and second ROs of the active BWP 1002 as the valid ROs 1042 for PRACH transmission using the S0 sub-BWP 1005 as the UL bandwidth, and with the remaining six ROs of the active BWP 1002 identified as the non-valid (e.g., invalid, etc.) ROs 1048. The non-valid ROs 1048 may also be referred to as invalidated ROs. The non-valid (e.g., invalidated) ROs 1048 can be the configured ROs that may not be used for PRACH transmission when the S0 sub-BWP 1005 is set as the UL bandwidth for PRACH transmission and RACH procedure. In some cases, the UE may implement the determination of non-valid (e.g., invalidated) ROs 1048 based on removing each invalidated RO from the set of the plurality of configured ROs, while the UE is in the corresponding sub-BWP state for which the invalidated ROs are to be removed.

In another example, based on the current (e.g., active) sub-BWP being set to the high-power (e.g., higher-power) state S1 sub-BWP 1010, the UE may determine the set of valid ROs (determined at identification 936) as the subset of ROs within the active BWP 1002 that are also within the S1 sub-BWP 1010 (e.g., all eight ROs of the active BWP 1002 are also within the high-power (e.g., higher-power) state S1 sub-BWP 1010). The validity rule determination 1050 of the set of valid ROs 1052 for the S1 sub-BWP 1010 is illustrated in FIG. 10 as including all eight ROs of the active BWP 1002 as the valid ROs 1052 for PRACH transmission using the S1 sub-BWP 1010 as the UL bandwidth.

In another illustrative example, the systems and techniques can use the common (e.g., shared) RACH configuration across the sub-BWPs of the active BWP of the UE, and the UE may determine one or more additional ROs for a narrower bandwidth of either the first or second sub-BWP. For example, the first sub-BWP can have a narrower bandwidth than the second sub-BWP, and the UE may determine and use one or more additional ROs for the first sub-BWP as valid candidate ROs for the PRACH transmission. The one or more additional ROs can be ROs that are not included in or indicated by the set of the plurality of configured ROs determined according to the shared RACH configuration. In some examples,. The one or more additional ROs can be determined based on a modulo operation configured according to a bandwidth of the first sub-BWP (e.g., bandwidth of the sub-BWP where the additional RO(s) are configured for use with the PRACH transmission, etc.).

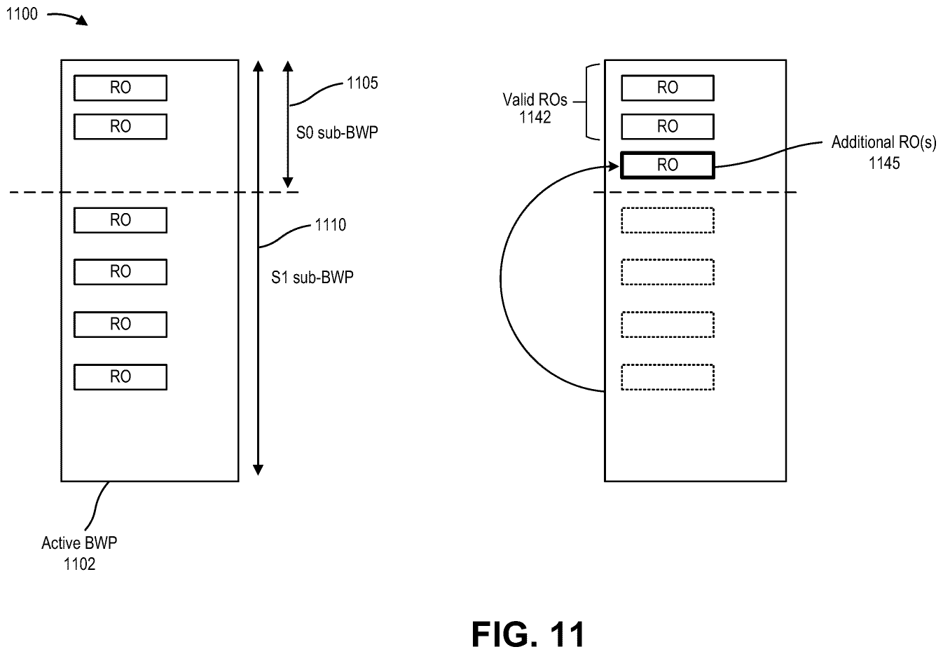

For example, FIG. 11 is a diagram illustrating an example configuration 1100 of an active BWP 1102, which can correspond to and/or can be the same as or similar to the active BWP 1002 of FIG. 10. The active BWP 1102 includes a first bandwidth corresponding to an S0 sub-BWP 1105, which can be the same as or similar to the S0 sub-BWP 1005 of FIG. 10. The active BWP 1102 includes a second bandwidth corresponding to an S1 sub-BWP 1110, which can be the same as or similar to the S1 sub-BWP 1010 of FIG. 10. In the example configuration 1100, the active BWP 1102 includes a total of six configured ROs, where the first and second configured ROs are within the S0 sub-BWP 1105 and are also within the S1 sub-BWP 1110 (e.g., as the S1 sub-BWP 1110 includes the S0 sub-BWP 1105), and where the third, fourth, fifth, and sixth configured ROs are within the S1 sub-BWP 1110 only (e.g., are not within the S1 sub-BWP 1105).

The UE may determine the set of valid ROs for UL PRACH transmission responsive to a PRACH trigger based on an initial determination of a set of valid ROs comprising the configured ROs that are within the active sub-BWP, as noted above. For example, the initial determination when the S0 sub-BWP 1105 is the active sub-BWP comprises the first and second ROs within the active BWP 1102 only, and the initial determination when the S1 sub-BWP 1110 is the active sub-BWP comprises the first through sixth ROs (e.g., all ROs) within the active BWP 1102.

In one illustrative example, the UE can be configured to compensate the lower number of valid ROs that are within the bandwidth of the low-power state S0 sub-BWP 1105 based on the UE determining one or more additional ROs that may be used for the PRACH transmission with the low-power state S0 sub-BWP 1105 as the UL bandwidth. The one or more additional ROs can be ROs that are not included in the set of configured ROs for the active BWP 1102. In some examples, the UE may be configured to determine one or more additional ROs when using the low-power S0 sub-BWP 1105 for PRACH transmission UL, while the UE does not determine or use additional ROs when using the high-power (e.g., higher-power) S1 sub-BWP 1110 for PRACH transmission UL.

In some aspects, to determine the additional ROs for the low-power state S0 and the corresponding S0 sub-BWP 1105 as the UL sub-BWP for PRACH transmission, the UE can determine a respective frequency location for each additional RO of the one or more additional ROs 1145 that are identified by the UE. The frequency location for the additional ROs 1145 can be determined by the UE based on a modulo operation configured according to the first bandwidth (e.g., a modulo operation configured according to the first bandwidth BW₀ equal to the bandwidth of the low-power state S0 sub-BWP 1105). In one illustrative example, the frequency location information for the additional ROs 1145 can be determined (e.g., calculated or otherwise determined) by the UE based on mod (frequency start, sub-BWP bandwidth). For example, for the S0 sub-BWP 1105 with bandwidth BW₀, the frequency location information for the additional ROs 1145 can be determined based on mod (frequency start, BW₀). In another example, the additional ROs 1145 may be semi-statically activated and/or deactivated based on signaling from the network entity to the UE, etc.

In some cases, the number of additional ROs 1145 that may be added for the low-power S0 state and corresponding sub-BWP 1105 is less than or equal to the number of invalid ROs (e.g., out of the set of the plurality of configured ROs within the active BWP 1102) that are determined for and/or correspond to the use of the low-power S0 state and corresponding sub-BWP 1105 as the UL bandwidth for PRACH transmission. For example, four of the six configured ROs within active BWP 1102 are invalid ROs when the low-power S0 sub-BWP 1105 is used as the UL bandwidth for PRACH transmission, and the additional ROs 1145 can comprise up to a maximum of four different additional ROs 1145 that the UE can use for the RACH procedure and PRACH transmission while in the S0 sub-BWP 1105. In some cases, the additional ROs 1145 can comprise a quantity of additional ROs that is less than or equal to a configured threshold value indicative of the maximum number of additional ROs. The threshold value may be included in the configuration information for the light adaptation sub-BWP switching and/or can be included in the RACH configuration information, etc. In some cases, the threshold value can be indicative of a maximum number of ROs, where the sum of the valid configured ROs 1142 comprising configured ROs within the S0 sub-BWP 1105 plus the one or more additional ROs 1145 is less than or equal to the maximum threshold number of total ROs for the UL bandwidth of the RACH procedure and PRACH transmission by the UE.

In some cases, determining the additional ROs 1145 for the low-power S0 sub-BWP 1105 can be based on a UE dedicated RO configuration, where the UE reinterprets ROs outside of the active sub-BWP (e.g., low-power S0 sub-BWP 1105) as the additional ROs 1145, using the modulo operation noted above. In some cases, the additional ROs 1145 can be located within the frequency domain based on mod (frequency offset, S0 sub-BWP 1105 bandwidth), as noted above.

In some examples, SSB-RO mapping can be performed for the additional ROs 1145 used for the low-power S0 sub-BWP 1105 PRACH transmission UL bandwidth based on the ROs being numbered across both RO types (e.g., valid configured ROs 1142 and additional ROs 1145). For example, the low-power state S0 associated with the sub-BWP 1105 of FIG. 11 loses four configured ROs based on the third, fourth, fifth, and sixth configured ROs within the active BWP 1102 being outside the bandwidth of the S0 sub-BWP 1105. Up to four additional ROs 1145 may be compensated by the UE, and SSB-RO mapping can be performed by increasing index order over time or frequency including both types of ROs. For example, SSB-RO mapping index=1 can be used for the first RO within the set of valid configured ROs 1142; SSB-RO mapping index=2 can be used for the second RO within the set of valid configured ROs 1142; SSB-RO mapping index=3 can be used for the first additional RO within the additional ROs 1145; SSB-RO index=4 can be used for the second additional RO within the additional ROs 1145; SSB-RO index=5 can be used for the third additional RO within the additional ROs 1145; and SB-RO index=6 can be used for the fourth additional RO within the additional ROs 1145.

In some aspects, the ROs can be numbered separately across the different types. For example, the set of valid configured ROs 1142 can be indexed starting from an SSB-RO index=1, and the one or more additional ROs 1145 can be indexed starting from a separate SSB-RO index=1. In some cases, a PRACH mask index can be used to indicate the mask over the combined PRACH occasions, including the valid configured ROs 1142 and the one or more additional ROs 1145. In some examples, a separate PRACH mask index can be used for the additional ROs 1145 (e.g., a first PRACH mask index corresponding to the valid configured ROs 1142, a second PRACH mask index corresponding to the additional ROs 1145). In some examples, the UE activation of additional ROs 1145 can be based on UE capability information, which can be transmitted to the network entity and/or can be RRC configured. For example, the UE may transmit capability information and the network entity can RRC configure enablement or disablement (e.g., non-enablement) of the use of additional ROs 1145 for RACH procedures and/or PRACH transmissions by the UE within the active BWP 1102 configured with at least the first and second S0 sub-BWP 1105 and S1 sub-BWP 1110, respectively. For example, the network entity can transmit (and the UE can receive) an RRC configuration indicative of permission for the UE to use one or more additional ROs 1145, and/or the network entity may transmit (and the UE may receive) an RRC configuration indicative of no permission for the UE to use the one or more additional ROs 1145.

In some cases, the UE may receive the PRACH trigger 932 of FIG. 9 as the PDCCH order for requesting RACH procedure by the network entity. The UE may be configured to determine whether the transmit the PRACH transmission in the first or second sub-BWP (e.g., S0 sub-BWP 1105 or S1 sub-BWP 1110, etc.) based on an indication by the PDCCH order DCI self-contained (e.g., based on the state index), and/or based on selection autonomously by the UE. In some cases, when the UE is in the low-power sate and receives the PDCCH order (e.g., when the UE uses S0 sub-BWP 1105 as the active sub-BWP and receives the PDCCH order), the UE may be configured to automatically transition to the high-power (e.g., higher-power) state S1 with the wider sub-BWP S1 sub-BWP 1110 for transmission of the RACH, as noted above for the example switching timeline 900 of FIG. 9. After PRACH transmission, the UE can monitor PDCCH with CRC scrambled with RA-RNTI which schedules the RAR PDSCH in the high-power (e.g., higher-power) state (e.g., wider sub-BWP S1 sub-BWP 1110).

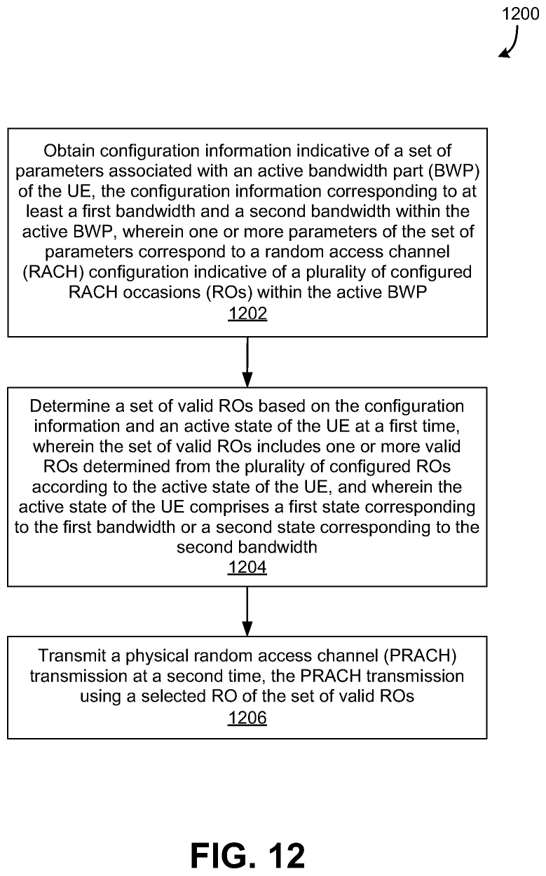

FIG. 12 is a flowchart diagram illustrating an example of a process 1200 for wireless communications. In some aspects, the process 1200 can be a process for wireless communications by a network entity (e.g., a UE, etc.). For example, the process 1200 can be a process for wireless communications by a UE. In some examples, the process 1200 can be performed by a network entity or network device (or apparatus) or a component (e.g., a chipset, codec, etc.) of the network entity or device. The process 1200 can be performed by one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the network entity or device or apparatus. The operations of the process 1200 may be implemented as software components that are executed and run on one or more processors (e.g., processor 1310 and/or processing system 1302 of FIG. 13, or other processor(s)).

In some examples, the process 1200 can be performed by a UE, including any of the various UEs described herein. In some aspects, the process 1200 can be performed by a UE, smartphone, mobile computing device, user computer device, etc. The process 1200 can be performed by a component or system (e.g., a chipset) of a network device (e.g., one or more of UEs 104, 152, 164, 182, 190 of FIG. 1; UE 104 of FIG. 2; UEs 104 of FIG. 3; wireless device 407 of FIG. 4; computing system 1300 and/or processing system 1302 of FIG. 13; etc.). The network device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1200 may be implemented as software components that are executed and run on one or more processors (e.g., the transmit processor 264, the receive processor 258, the TX MIMO processor 266, the MIMO detector 256 of FIG. 2, the processing system 470 of FIG. 4, the one or more processors 484 of FIG. 4, the processing system 1302 of FIG. 13, and/or the processor 1310 of FIG. 13, or other processor(s) (e.g., such as one or more other processors included within and/or associated with the processing system 470 of FIG. 4, the processing system 1302 of FIG. 13, etc.). Further, the transmission and reception of signals by the network entity in the process 1200 may be enabled, for example, by one or more antennas, one or more transceivers (e.g., wireless transceiver(s)), and/or other communication components (e.g., the transmit processor 264, the receive processor 258, the TX MIMO processor 266, the MIMO detector 256, the modulator(s)/demodulator(s) 254a through 254t, and/or the antenna(es) 252a through 252t of FIG. 2, the antenna(es) 487 of FIG. 4, the wireless transceiver(s) 478 of FIG. 4, the communications interface 1340 of FIG. 13, or other antennae(s), transceiver(s), and/or component(s)).

At block 1202, the apparatus (or component thereof) can obtain configuration information indicative of a set of parameters associated with an active bandwidth part (BWP) of the UE, the configuration information corresponding to at least a first bandwidth and a second bandwidth within the active BWP, wherein one or more parameters of the set of parameters correspond to a random access channel (RACH) configuration indicative of a plurality of configured RACH occasions (ROs) within the active BWP. For example, the first bandwidth and the second bandwidth within the active BWP can be sub-BWPs. In some examples, the first bandwidth can be the sub-BWP (e.g., Bandwidth₀) associated with the first state 705 of FIG. 7, and/or the second bandwidth can be the sub-BWP (e.g., Bandwidth₁) associated with the second state 710 of FIG. 7, etc. In some cases, the first bandwidth can correspond to the first state S0 855 and bandwidth BW₀ of FIG. 8A, and the second bandwidth can correspond to the second state S1 860 and the bandwidth BW₁ of FIG. 8A, etc. In some cases, the first bandwidth can correspond to the sub-BWP 905 of FIG. 9, and the second bandwidth can correspond to the sub-BWP 910 of FIG. 9, etc.

In some cases, the second bandwidth includes the first bandwidth. For example, the second bandwidth can be wider than the first bandwidth, and the first bandwidth can be a subset of the second bandwidth. In some examples, a first state corresponding to the first bandwidth is a low-power state of the UE, and a second state corresponding to the second bandwidth is a higher-power state of the UE, where the first bandwidth is smaller than the second bandwidth. In some cases, the first bandwidth can be a first sub-BWP of the active BWP and the second bandwidth can be a second sub-BWP of the active BWP, where the first sub-BWP is mapped to the first state comprising a low-power state of the UE.

In some cases, the configuration information includes the RACH configuration, where the RACH configuration is shared by a first sub-BWP comprising the first bandwidth and by a second sub-BWP comprising the second bandwidth. In some examples, the apparatus (or component thereof) can receive an indication of a RACH trigger to perform a PRACH transmission, and may select the first bandwidth or the second bandwidth as the active state of the UE to perform the PRACH transmission at the second time, the selection based on an indication corresponding to the RACH trigger. In some cases, the RACH trigger comprises downlink control information (DCI), and wherein the indication comprises a physical downlink control channel (PDCCH) order of the DCI.

At block 1204, the apparatus (or component thereof) can determine a set of valid ROs based on the configuration information and an active state of the UE at a first time, wherein the set of valid ROs includes one or more valid ROs determined from the plurality of configured ROs according to the active state of the UE, and wherein the active state of the UE comprises a first state corresponding to the first bandwidth or a second state corresponding to the second bandwidth. For example, the determination of the set of valid ROs can correspond to the identification of the RO(s) for PRACH transmission at 936 of FIG. 9, etc.

In some examples, the active state of the UE at the first time is the first state, and, to determine the set of valid ROs based on the active state of the UE at the first time, the apparatus (or component thereof) may be configured to determine one or more configured ROs of the plurality of configured ROs are outside the first bandwidth. For example, the active state of the UE can be the first state corresponding to the sub-BWP 1005 of FIG. 10, and the one or more ROs outside the first bandwidth can be the ROs that are included within the sub-BWP 1010 but not included within the sub-BWP 1005 of FIG. 10.

In some cases, the apparatus (or component thereof) can switch the active state of the UE to the second state, wherein the one or more configured ROs outside the first bandwidth are within the second bandwidth. For example, the UE can switch the active state to the state corresponding to the S1 sub-BWP 1010 of FIG. 10 and/or the S1 UL sub-BWP 910 of FIG. 9, etc. In some examples, the apparatus (or component thereof) can determine the set of valid ROs to include each respective RO of the plurality of configured ROs that is within the second bandwidth. In some cases, the active state of the UE at the second time is the second state, and the selected RO used for the PRACH transmission is outside the first bandwidth and within the second bandwidth.

In some examples, the apparatus (or component thereof) can be configured to switch the active state of the UE to return to the first state after the PRACH transmission. For example, the active state of the UE can switch to return to the S0 state for the UL sub-BWP 905 of FIG. 9 after the PRACH transmission and the sub-BWP switching determination 946 corresponding to RA procedure completion of FIG. 9, etc. In some cases, the first state corresponding to the first bandwidth is a low-power state of the UE, and the second state corresponding to the second bandwidth is a higher-power state of the UE. In some examples, the first bandwidth is smaller than the second bandwidth. In some cases, the second bandwidth includes the first bandwidth, and the one or more valid ROs determined from the plurality of configured ROs comprises respective ROs of the plurality of configured ROs that are within at least one of the first bandwidth or the second bandwidth, based on the UE switching the active state between the first time and the second time.

In some examples the one or more valid ROs determined from the plurality of configured ROs according to the active state of the UE at the first time comprises: respective ROs of the plurality of configured ROs that are within the first bandwidth, in response to the active state of the UE being the first state, or comprises respective ROs of the plurality of configured ROs that are within the second bandwidth, based on the active state of the UE being the second state.

In some examples, the active state of the UE at the second time is the same as the active state of the UE at the first time, and the set of valid ROs for the PRACH transmission comprises respective ROs of the plurality of configured ROs that are within a bandwidth corresponding to the active state. In some cases, to determine the set of valid ROs, the apparatus (or component thereof) can be configured to invalidate each RO of the plurality of configured ROs that is not within the bandwidth corresponding to the active state, where each invalidated RO is removed from the plurality of configured ROs. For example, the invalidated ROs can be the non-valid ROs 1048 of FIG. 10, etc. The apparatus (or component thereof) can determine the set of valid ROs as a remaining subset of ROs of the plurality of configured ROs with each invalidated RO removed. For example, the set of valid ROs can correspond to the valid ROs 1042 of FIG. 10, and/or the validity rule determination 1040 of FIG. 10, etc.

In some examples, the active state of the UE at the first and second times is the first state, the corresponding first bandwidth being smaller than the second bandwidth. In some examples, the set of valid ROs includes each respective RO of the plurality of configured ROs that is within the first bandwidth, and further includes one or more additional ROs within the first bandwidth, where the plurality of configured ROs does not include the one or more additional ROs. For example, the set of valid ROs can be the same as or similar to the valid configured ROs 1142 of FIG. 11, which may be the respective ROs of the plurality of configured ROs within the active BWP 1102 that are included within the S0 sub-BWP 1105 of FIG. 11.

The one or more additional ROs can correspond to, and/or can be the same as or similar to the additional ROs 1145 of FIG. 11. In some examples, the one or more additional ROs are determined based on a semi-static activation or deactivation received by the UE. In some examples, to determine the set of valid ROs, the apparatus (or component thereof) can be configured to determine the respective ROs of the plurality of configured ROs that are within the first bandwidth, and determine the one or more additional ROs based on a modulo operation configured according to the first bandwidth. For example, the one or more additional ROs can be determined based on a modulo operation configured according to the first bandwidth (e.g., the S0 sub-BWP 1105 bandwidth, etc., of FIG. 11). In some cases, the apparatus (or component thereof) can be configured to determine respective frequency location information for each additional RO of the one or more additional ROs based on the modulo operation.

In some examples, the apparatus (or component thereof) may be configured to determine synchronization signal block (SSB)-RO mapping information for the set of valid ROs that is the same as an SSB-RO mapping information for the plurality of configured ROs. In some cases, the apparatus (or component thereof) may be configured to determine PRACH mask index information indicative of a mask over the set of valid ROs including the one or more additional ROs.

In some examples, the apparatus (or component thereof) may be configured to determine a first PRACH mask index information for the set of valid ROs corresponding to the respective ROs of the plurality of configured ROs that are within the first bandwidth. The apparatus (or component thereof) can determine a second PRACH mask index information for the set of valid ROs corresponding to the one or more additional ROs. In some cases, the apparatus (or component thereof) can receive a radio resource control (RRC) configuration indicative of permission for the UE to use additional ROs. The apparatus (or component thereof) may determine the one or more additional ROs based on the permission for the UE to use additional ROs.

In some examples, a number of additional ROs included in the one or more additional ROs is less than or equal to a number of invalid ROs of the plurality of configured ROs. For example, the number of additional ROs 1145 of FIG. 11 can be less than or equal to the number of invalid ROs of the active BWP 1102 plurality of configured ROs of FIG. 11. In some cases, the additional ROs, the valid ROs, and/or the invalid ROs may be determined corresponding to the identification 936 of the RO(s) for PRAHJC transmission of FIG. 9, etc. In some examples, a number of additional ROs included in the one or more additional ROs is less than or equal to a configured threshold number of ROs for the active BWP.

At block 1206, the apparatus (or component thereof) can transmit a physical random access channel (PRACH) transmission at a second time, the PRACH transmission using a selected RO of the set of valid ROs. For example, the apparatus (or component thereof) can transmit, via a transceiver, the PRACH transmission at the second time and using the selected RO of the set of valid ROs. The transceiver can be a transceiver in communication with the apparatus (or component thereof). In some cases, the transceiver is in communication with a processing system of the apparatus. In some examples, the transceiver can be included in the apparatus. For example, the apparatus can include a transceiver corresponding to the one or more wireless transceivers 478 of FIG. 4, among various others, where the one or more wireless transceivers 478 are in communication with the processing system 470 of the wireless device 407 of FIG. 4. In some examples, the apparatus (or component thereof) may transmit the PRACH transmission at the second time via a transceiver corresponding to one or more antennas, one or more transceivers (e.g., wireless transceiver(s)), and/or other communication components (e.g., the transmit processor 264, the receive processor 258, the TX MIMO processor 266, the MIMO detector 256, the modulator(s)/demodulator(s) 254a through 254t, and/or the antenna(es) 252 a through 252t of FIG. 2, the antenna(es) 487 of FIG. 4, the wireless transceiver(s) 478 of FIG. 4, the communications interface 1340 of FIG. 13, or other antennae(s), transceiver(s), and/or component(s)). In some examples, the PRACH transmission can be transmitted at a second time and using a selected RO of the set of valid ROs within and/or corresponding to the S1 UL sub-BWP 910 of FIG. 9, based on the sub-BWP switching determination 942 to switch the UE active state from the S0 UL sub-BWP 905 to the S1 UL sub-BWP 910 in order to perform the PRACH transmission.

In some cases, the apparatus (or component thereof) can receive an indication of a RACH trigger to perform a PRACH transmission, and may select the first bandwidth or the second bandwidth as the active state of the UE to perform the PRACH transmission at the second time, the selection based on an indication corresponding to the RACH trigger. In some examples, the apparatus (or component thereof) can receive the indication of the RACH trigger via the transceiver, and may perform the PRACH transmission by transmitting, via the transceiver, the PRACH transmission at the second time. In some examples, the RACH trigger can correspond to the PRACH trigger 932 of FIG. 9. The RACH trigger can cause the UE to perform a RACH procedure, for example using one or more parameters of the configuration information corresponding to and/or indicative of the RACH configuration, etc. The RACH procedure can include and/or correspond to the identification of the RO(s) for PRACH transmission at the identification 936 of FIG. 9, where the RACH procedure and identification 936 of the RO(s) can be based on a CFRA and/or CBRA procedure, etc., that is triggered and/or initiated based on the RACH trigger (e.g., PRACH trigger 932 of FIG. 9), etc. In some cases, the RACH trigger comprises downlink control information (DCI), and the indication comprises a physical downlink control channel (PDCCH) order of the DCI. The DCI can correspond to, and/or can be the same as or similar to the DCI 605 of FIG. 6, etc.

In some examples, the processes described herein (e.g., process 1200 and/or other process described herein) may be performed by a computing device or apparatus (e.g., a network node such as a UE, base station, a portion of a base station, etc.). For example, as noted above, the process 1200 may be performed by a UE and/or network entity (e.g., base station, gNB, etc.). In some examples, the process 1200 may be performed by a computing device with the computing system 1300 shown in FIG. 13. For example, a wireless communication device with the computing architecture shown in FIG. 13 may include the components of the UE and/or the network entity (e.g., base station, gNB, etc.) and may implement the operations of FIG. 12 and/or process 1200, etc.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth^{TM} standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 1200 is illustrated as a logical flow diagram, the operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 1200 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a diagram illustrating an example of a system for implementing certain aspects of the present technology. In particular, FIG. 13 illustrates an example of computing system 1300 including a processing system 1302, which may be for example any computing device making up internal computing system, a remote computing system, a camera, or any component thereof in which the components of the system are in communication with each other using connection 1305. Connection 1305 may be a physical connection using a bus, or a direct connection into processor 1310 (and/or one or more other processors included within and/or associated with the processing system 1302), such as in a chipset architecture. Connection 1305 may also be a virtual connection, networked connection, or logical connection.

In some aspects, computing system 1300 and/or the processing system 1302 can be provided as a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

The example processing system 1302 includes at least one processing unit (CPU or processor) 1310 and connection 1305 that communicatively couples various system components including system memory 1315, such as read-only memory (ROM) 1320 and random access memory (RAM) 1325 to processor 1310. The processing system 1302 may include a cache 1312 of high-speed memory connected directly with, in close proximity to, or integrated as part of processor 1310 and/or one or more other processors included within and/or associated with the processing system 1302.

Processor 1310 may include any general-purpose processor and a hardware service or software service, such as services 1332, 1334, and 1336 stored in storage device 1330, configured to control processor 1310 and/or one or more other processors included within and/or associated with the processing system 1302, as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, processing system 1302 includes an input device 1345, which may represent any number of input mechanisms, such as a microphone for speech, a touch-sensitive screen for gesture or graphical input, keyboard, mouse, motion input, speech, etc. Processing system 1302 may also include output device 1335, which may be one or more of a number of output mechanisms. In some examples, multimodal systems may enable a user to provide multiple types of input/output to communicate with processing system 1302.

Processing system 1302 may include communications interface 1340, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard, and Visa (EMV) chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1330 may include software services, servers, services, etc., that when the code that defines such software is executed by the processor 1310 and/or one or more other processors included within and/or associated with the processing system 1302, it causes the system to perform a function. In some aspects, a hardware service that performs a particular function may include the software component stored in a computer-readable medium in connection with the necessary hardware components, such as processor 1310 (e.g., and/or one or more other processors included within and/or associated with the processing system 1302), connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some examples the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other examples, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for wireless communication at a user equipment (UE), comprising: a processing system; and a transceiver in communication with the processing system, the processing system configured to: obtain configuration information indicative of a set of parameters associated with an active bandwidth part (BWP) of the UE, the configuration information corresponding to at least a first bandwidth and a second bandwidth within the active BWP, wherein one or more parameters of the set of parameters correspond to a random access channel (RACH) configuration indicative of a plurality of configured RACH occasions (ROs) within the active BWP; determine a set of valid ROs based on the configuration information and an active state of the UE at a first time, wherein the set of valid ROs includes one or more valid ROs determined from the plurality of configured ROs according to the active state of the UE, and wherein the active state of the UE comprises a first state corresponding to the first bandwidth or a second state corresponding to the second bandwidth; and transmit, via the transceiver, a physical random access channel (PRACH) transmission at a second time, the PRACH transmission using a selected RO of the set of valid ROs.

Aspect 2. The apparatus of Aspect 1, wherein the active state of the UE at the first time is the first state, and wherein, to determine the set of valid ROs based on the active state of the UE at the first time, the processing system is configured to: determine one or more configured ROs of the plurality of configured ROs are outside the first bandwidth; switch the active state of the UE to the second state, wherein the one or more configured ROs outside the first bandwidth are within the second bandwidth; and determine the set of valid ROs to include each respective RO of the plurality of configured ROs that is within the second bandwidth.

Aspect 3. The apparatus of Aspect 2, wherein the active state of the UE at the second time is the second state, and wherein the selected RO used for the PRACH transmission is outside the first bandwidth and within the second bandwidth.

Aspect 4. The apparatus of Aspect 3, wherein the processing system is configured to switch the active state of the UE to return to the first state after the PRACH transmission.

Aspect 5. The apparatus of any of Aspects 1 to 4, wherein: the first state corresponding to the first bandwidth is a low-power state of the UE; the second state corresponding to the second bandwidth is a higher-power state of the UE; and the first bandwidth is smaller than the second bandwidth.

Aspect 6. The apparatus of any of Aspects 1 to 5, wherein: the second bandwidth includes the first bandwidth; and the one or more valid ROs determined from the plurality of configured ROs comprises respective ROs of the plurality of configured ROs that are within at least one of the first bandwidth or the second bandwidth, based on the UE switching the active state between the first time and the second time.

Aspect 7. The apparatus of any of Aspects 1 to 6, wherein the one or more valid ROs determined from the plurality of configured ROs according to the active state of the UE at the first time comprises: respective ROs of the plurality of configured ROs that are within the first bandwidth, in response to the active state of the UE being the first state; or respective ROs of the plurality of configured ROs that are within the second bandwidth, based on the active state of the UE being the second state.

Aspect 8. The apparatus of any of Aspects 1 to 7, wherein the active state of the UE at the second time is the same as the active state of the UE at the first time, and wherein the set of valid ROs for the PRACH transmission comprises respective ROs of the plurality of configured ROs that are within a bandwidth corresponding to the active state.

Aspect 9. The apparatus of Aspect 8, wherein, to determine the set of valid ROs, the processing system is configured to: invalidate each RO of the plurality of configured ROs that is not within the bandwidth corresponding to the active state, wherein each invalidated RO is removed from the plurality of configured ROs; and determine the set of valid ROs as a remaining subset of ROs of the plurality of configured ROs with each invalidated RO removed.

Aspect 10. The apparatus of any of Aspects 1 to 9, wherein: the active state of the UE at the first and second times is the first state, the corresponding first bandwidth being smaller than the second bandwidth; and the set of valid ROs includes each respective RO of the plurality of configured ROs that is within the first bandwidth, and further includes one or more additional ROs within the first bandwidth, wherein the plurality of configured ROs does not include the one or more additional ROs.

Aspect 11. The apparatus of Aspect 10, wherein the one or more additional ROs are determined based on a semi-static activation or deactivation received by the UE.

Aspect 12. The apparatus of any of Aspects 10 to 11, wherein to determine the set of valid ROs, the processing system is configured to: determine the respective ROs of the plurality of configured ROs that are within the first bandwidth; and determine the one or more additional ROs based on a modulo operation configured according to the first bandwidth.

Aspect 13. The apparatus of Aspect 12, wherein the processing system is configured to determine respective frequency location information for each additional RO of the one or more additional ROs based on the modulo operation.

Aspect 14. The apparatus of any of Aspects 12 to 13, wherein the processing system is configured to determine synchronization signal block (SSB)-RO mapping information for the set of valid ROs that is the same as an SSB-RO mapping information for the plurality of configured ROs.

Aspect 15. The apparatus of any of Aspects 12 to 14, wherein the processing system is configured to determine PRACH mask index information indicative of a mask over the set of valid ROs including the one or more additional ROs.

Aspect 16. The apparatus of any of Aspects 12 to 15, wherein the processing system is configured to: determine a first PRACH mask index information for the set of valid ROs corresponding to the respective ROs of the plurality of configured ROs that are within the first bandwidth; and determine a second PRACH mask index information for the set of valid ROs corresponding to the one or more additional ROs.

Aspect 17. The apparatus of any of Aspects 12 to 16, wherein the processing system is configured to: receive, via the transceiver, a radio resource control (RRC) configuration indicative of permission for the UE to use additional ROs; and determine the one or more additional ROs based on the permission for the UE to use additional ROs.

Aspect 18. The apparatus of any of Aspects 10 to 17, wherein a number of additional ROs included in the one or more additional ROs is less than or equal to a number of invalid ROs of the plurality of configured ROs.

Aspect 19. The apparatus of any of Aspects 10 to 18, wherein a number of additional ROs included in the one or more additional ROs is less than or equal to a configured threshold number of ROs for the active BWP.

Aspect 20. The apparatus of any of Aspects 1 to 19, wherein the first bandwidth comprises a first sub-BWP of the active BWP and the second bandwidth comprises a second sub-BWP of the active BWP, and wherein the first sub-BWP is mapped to the first state comprising a low-power state of the UE.

Aspect 21. The apparatus of any of Aspects 1 to 20, wherein the configuration information includes the RACH configuration, and wherein the RACH configuration is shared by a first sub-BWP comprising the first bandwidth and by a second sub-BWP comprising the second bandwidth.

Aspect 22. The apparatus of any of Aspects 1 to 21, wherein the processing system is configured to: receive, via the transceiver, an indication of a RACH trigger to perform the PRACH transmission; and select the first bandwidth or the second bandwidth as the active state of the UE to perform the PRACH transmission at the second time, the selection based on an indication corresponding to the RACH trigger.

Aspect 23. The apparatus of Aspect 22, wherein the RACH trigger comprises downlink control information (DCI), and wherein the indication comprises a physical downlink control channel (PDCCH) order of the DCI.

Aspect 24. A method for wireless communication at a user equipment (UE), comprising: obtaining configuration information indicative of a set of parameters associated with an active bandwidth part (BWP) of the UE, the configuration information corresponding to at least a first bandwidth and a second bandwidth within the active BWP, wherein one or more parameters of the set of parameters correspond to a random access channel (RACH) configuration indicative of a plurality of configured RACH occasions (ROs) within the active BWP; determining a set of valid ROs based on the configuration information and an active state of the UE at a first time, wherein the set of valid ROs includes one or more valid ROs determined from the plurality of configured ROs according to the active state of the UE, and wherein the active state of the UE comprises a first state corresponding to the first bandwidth or a second state corresponding to the second bandwidth; and transmitting, via a transceiver of the UE, a physical random access channel (PRACH) transmission at a second time, the PRACH transmission using a selected RO of the set of valid ROs.

Aspect 25. The method of Aspect 24, wherein the active state of the UE at the first time is the first state, and wherein determining the set of valid ROs based on the active state of the UE at the first time includes: determining one or more configured ROs of the plurality of configured ROs are outside the first bandwidth; switching the active state of the UE to the second state, wherein the one or more configured ROs outside the first bandwidth are within the second bandwidth; and determining the set of valid ROs to include each respective RO of the plurality of configured ROs that is within the second bandwidth.

Aspect 26. The method of Aspect 25, wherein the active state of the UE at the second time is the second state, and wherein the selected RO used for the PRACH transmission is outside the first bandwidth and within the second bandwidth.

Aspect 27. The method of Aspect 26, further comprising switching the active state of the UE to return to the first state after the PRACH transmission.

Aspect 28. The method of any of Aspects 24 to 27, wherein: the first state corresponding to the first bandwidth is a low-power state of the UE; the second state corresponding to the second bandwidth is a higher-power state of the UE; and the first bandwidth is smaller than the second bandwidth.

Aspect 29. The method of any of Aspects 24 to 28, wherein: the second bandwidth includes the first bandwidth; and the one or more valid ROs determined from the plurality of configured ROs comprises respective ROs of the plurality of configured ROs that are within at least one of the first bandwidth or the second bandwidth, based on the UE switching the active state between the first time and the second time.

Aspect 30. The method of any of Aspects 24 to 29, wherein the one or more valid ROs determined from the plurality of configured ROs according to the active state of the UE at the first time comprises: respective ROs of the plurality of configured ROs that are within the first bandwidth, in response to the active state of the UE being the first state; or respective ROs of the plurality of configured ROs that are within the second bandwidth, based on the active state of the UE being the second state.

Aspect 31. The method of any of Aspects 24 to 30, wherein the active state of the UE at the second time is the same as the active state of the UE at the first time, and wherein the set of valid ROs for the PRACH transmission comprises respective ROs of the plurality of configured ROs that are within a bandwidth corresponding to the active state.

Aspect 32. The method of Aspect 31, wherein determining the set of valid ROs includes: invalidating each RO of the plurality of configured ROs that is not within the bandwidth corresponding to the active state, wherein each invalidated RO is removed from the plurality of configured ROs; and determining the set of valid ROs as a remaining subset of ROs of the plurality of configured ROs with each invalidated RO removed.

Aspect 33. The method of any of Aspects 24 to 32, wherein: the active state of the UE at the first and second times is the first state, the corresponding first bandwidth being smaller than the second bandwidth; and the set of valid ROs includes each respective RO of the plurality of configured ROs that is within the first bandwidth, and further includes one or more additional ROs within the first bandwidth, wherein the plurality of configured ROs does not include the one or more additional ROs.

Aspect 34. The method of Aspect 33, wherein the one or more additional ROs are determined based on a semi-static activation or deactivation received by the UE.

Aspect 35. The method of any of Aspects 33 to 34, wherein determining the set of valid ROs includes: determining the respective ROs of the plurality of configured ROs that are within the first bandwidth; and determining the one or more additional ROs based on a modulo operation configured according to the first bandwidth.

Aspect 36. The method of Aspect 35, further comprising determining respective frequency location information for each additional RO of the one or more additional ROs based on the modulo operation.

Aspect 37. The method of any of Aspects 35 to 36, further comprising determining synchronization signal block (SSB)-RO mapping information for the set of valid ROs that is the same as an SSB-RO mapping information for the plurality of configured ROs.

Aspect 38. The method of any of Aspects 35 to 37, further comprising determining PRACH mask index information indicative of a mask over the set of valid ROs including the one or more additional ROs.

Aspect 39. The method of any of Aspects 35 to 38, further comprising: determining a first PRACH mask index information for the set of valid ROs corresponding to the respective ROs of the plurality of configured ROs that are within the first bandwidth; and determining a second PRACH mask index information for the set of valid ROs corresponding to the one or more additional ROs.

Aspect 40. The method of any of Aspects 35 to 39, further comprising: receiving, via a transceiver of the UE, a radio resource control (RRC) configuration indicative of permission for the UE to use additional ROs; and determining the one or more additional ROs based on the permission for the UE to use additional ROs.

Aspect 41. The method of any of Aspects 33 to 40, wherein a number of additional ROs included in the one or more additional ROs is less than or equal to a number of invalid ROs of the plurality of configured ROs.

Aspect 42. The method of any of Aspects 33 to 41, wherein a number of additional ROs included in the one or more additional ROs is less than or equal to a configured threshold number of ROs for the active BWP.

Aspect 43. The method of any of Aspects 24 to 42, wherein the first bandwidth comprises a first sub-BWP of the active BWP and the second bandwidth comprises a second sub-BWP of the active BWP, and wherein the first sub-BWP is mapped to the first state comprising a low-power state of the UE.

Aspect 44. The method of any of Aspects 24 to 43, wherein the configuration information includes the RACH configuration, and wherein the RACH configuration is shared by a first sub-BWP comprising the first bandwidth and by a second sub-BWP comprising the second bandwidth.

Aspect 45. The method of any of Aspects 24 to 44, further comprising: receiving, via the transceiver, an indication of a RACH trigger to perform the PRACH transmission; and selecting the first bandwidth or the second bandwidth as the active state of the UE to perform the PRACH transmission at the second time, the selection based on an indication corresponding to the RACH trigger.

Aspect 46. The method of Aspect 45, wherein the RACH trigger comprises downlink control information (DCI), and wherein the indication comprises a physical downlink control channel (PDCCH) order of the DCI.

Aspect 47. A non-transitory computer-readable storage medium comprising instructions stored thereon which, when executed by at least one processor, causes the at least one processor to perform operations according to any of Aspects 1 to 23.

Aspect 48. An apparatus for wireless communication comprising one or more means for performing operations according to any of Aspects 1 to 23.

What is claimed is:

1. An apparatus for wireless communication at a user equipment (UE), comprising:
a processing system; and
a transceiver in communication with the processing system, the processing system configured to:
obtain configuration information indicative of a set of parameters associated with an active bandwidth part (BWP) of the UE, the configuration information corresponding to at least a first bandwidth and a second bandwidth within the active BWP, wherein one or more parameters of the set of parameters correspond to a random access channel (RACH) configuration indicative of a plurality of configured RACH occasions (ROs) within the active BWP;
determine a set of valid ROs based on the configuration information and an active state of the UE at a first time, wherein the set of valid ROs includes one or more valid ROs determined from the plurality of configured ROs according to the active state of the UE, and wherein the active state of the UE comprises a first state corresponding to the first bandwidth or a second state corresponding to the second bandwidth; and
transmit, via the transceiver, a physical random access channel (PRACH) transmission at a second time, the PRACH transmission using a selected RO of the set of valid ROs.

2. The apparatus of claim 1, wherein the active state of the UE at the first time is the first state, and wherein, to determine the set of valid ROs based on the active state of the UE at the first time, the processing system is configured to:
determine one or more configured ROs of the plurality of configured ROs are outside the first bandwidth;
switch the active state of the UE to the second state, wherein the one or more configured ROs outside the first bandwidth are within the second bandwidth; and
determine the set of valid ROs to include each respective RO of the plurality of configured ROs that is within the second bandwidth.

3. The apparatus of claim 2, wherein the active state of the UE at the second time is the second state, and wherein the selected RO used for the PRACH transmission is outside the first bandwidth and within the second bandwidth.

4. The apparatus of claim 3, wherein the processing system is configured to switch the active state of the UE to return to the first state after the PRACH transmission.

5. The apparatus of claim 1, wherein:
the first state corresponding to the first bandwidth is a low-power state of the UE;
the second state corresponding to the second bandwidth is a higher-power state of the UE; and
the first bandwidth is smaller than the second bandwidth.

6. The apparatus of claim 1, wherein:
the second bandwidth includes the first bandwidth; and
the one or more valid ROs determined from the plurality of configured ROs comprises respective ROs of the plurality of configured ROs that are within at least one of the first bandwidth or the second bandwidth, based on the UE switching the active state between the first time and the second time.

7. The apparatus of claim 1, wherein the one or more valid ROs determined from the plurality of configured ROs according to the active state of the UE at the first time comprises:
respective ROs of the plurality of configured ROs that are within the first bandwidth, in response to the active state of the UE being the first state; or
respective ROs of the plurality of configured ROs that are within the second bandwidth, based on the active state of the UE being the second state.

8. The apparatus of claim 1, wherein the active state of the UE at the second time is the same as the active state of the UE at the first time, and wherein the set of valid ROs for the PRACH transmission comprises respective ROs of the plurality of configured ROs that are within a bandwidth corresponding to the active state.

9. The apparatus of claim 8, wherein, to determine the set of valid ROs, the processing system is configured to:
invalidate each RO of the plurality of configured ROs that is not within the bandwidth corresponding to the active state, wherein each invalidated RO is removed from the plurality of configured ROs; and
determine the set of valid ROs as a remaining subset of ROs of the plurality of configured ROs with each invalidated RO removed.

10. The apparatus of claim 1, wherein:
the active state of the UE at the first and second times is the first state, the corresponding first bandwidth being smaller than the second bandwidth; and
the set of valid ROs includes each respective RO of the plurality of configured ROs that is within the first bandwidth, and further includes one or more additional ROs within the first bandwidth, wherein the plurality of configured ROs does not include the one or more additional ROs.

11. The apparatus of claim 10, wherein the one or more additional ROs are determined based on a semi-static activation or deactivation received by the UE.

12. The apparatus of claim 10, wherein to determine the set of valid ROs, the processing system is configured to:
determine the respective ROs of the plurality of configured ROs that are within the first bandwidth; and
determine the one or more additional ROs based on a modulo operation configured according to the first bandwidth.

13. The apparatus of claim 12, wherein the processing system is configured to determine respective frequency location information for each additional RO of the one or more additional ROs based on the modulo operation.

14. The apparatus of claim 12, wherein the processing system is configured to determine synchronization signal block (SSB)-RO mapping information for the set of valid ROs that is the same as an SSB-RO mapping information for the plurality of configured ROs.

15. The apparatus of claim 12, wherein the processing system is configured to determine PRACH mask index information indicative of a mask over the set of valid ROs including the one or more additional ROs.

16. The apparatus of claim 12, wherein the processing system is configured to:
receive, via the transceiver, a radio resource control (RRC) configuration indicative of permission for the UE to use additional ROs; and
determine the one or more additional ROs based on the permission for the UE to use additional ROs.

17. The apparatus of claim 10, wherein a number of additional ROs included in the one or more additional ROs is less than or equal to at least one of: a number of invalid ROs of the plurality of configured ROs, or a configured threshold number of ROs for the active BWP.

18. The apparatus of claim 1, wherein the first bandwidth comprises a first sub-BWP of the active BWP and the second bandwidth comprises a second sub-BWP of the active BWP, and wherein the first sub-BWP is mapped to the first state comprising a low-power state of the UE.

19. The apparatus of claim 1, wherein the configuration information includes the RACH configuration, and wherein the RACH configuration is shared by a first sub-BWP comprising the first bandwidth and by a second sub-BWP comprising the second bandwidth.

20. A method for wireless communication at a user equipment (UE), comprising:
obtaining configuration information indicative of a set of parameters associated with an active bandwidth part (BWP) of the UE, the configuration information corresponding to at least a first bandwidth and a second bandwidth within the active BWP, wherein one or more parameters of the set of parameters correspond to a random access channel (RACH) configuration indicative of a plurality of configured RACH occasions (ROs) within the active BWP;
determining a set of valid ROs based on the configuration information and an active state of the UE at a first time, wherein the set of valid ROs includes one or more valid ROs determined from the plurality of configured ROs according to the active state of the UE, and wherein the active state of the UE comprises a first state corresponding to the first bandwidth or a second state corresponding to the second bandwidth; and
transmitting, via a transceiver of the UE, a physical random access channel (PRACH) transmission at a second time, the PRACH transmission using a selected RO of the set of valid ROs.
